(19) United States
(12) Patent Application Publication
(10) Pub. No.: US 2023/0007491 A1
(43) Pub. Date: Jan. 5, 2023

(54) MANAGING A SUBSCRIPTION IDENTIFIER ASSOCIATED WITH A DEVICE

(71) Applicant: TELEFONAKTIEBOLAGET LM ERICSSON (PUBL), STOCKHOLM (SE)

(72) Inventors: Bernard Smeets, DALBY (SE); Per Ståhl, KLAGSHAMN (SE); Qiang Li, TÄBY (SE)

(21) Appl. No.: 17/780,868

(22) PCT Filed: Nov. 28, 2019
(86) PCT No.: PCT/EP2019/082879

§ 371 Date: May 27, 2022

(51) Int. Cl. H04W 12/30; H04W 8/20; H04W 8/22; H04W 60/00; H04W 12/40

(52) U.S. Cl. CPC H04W 12/35; H04W 8/205; H04W 8/22; H04W 60/00; H04W 12/40

(57) ABSTRACT

A system is disclosed for managing a communication network subscription identifier associated with a device. The system comprises a Core Network node configured to provide a subscription identifier for the device to a Device Management node with management responsibility for the device. The system further comprises a Verification node configured to receive from the Device Management node the subscription identifier and a characteristic of the device, and to bind the subscription identifier to the characteristic such that the subscription identifier is uniquely associated with the characteristic. The system further comprises a Network Access node configured to obtain the subscription identifier from the device. The Verification node, Network Access node and Core Network node are configured to cooperate to verify that the device from which the Network Access node obtained the subscription identifier is in possession of the characteristic that is bound to the subscription identifier.

### TECHNICAL FIELD

The present disclosure relates to a system, methods and nodes for managing a communication network subscription identifier that is associated with a device. The present disclosure also relates to a computer program and a computer program product configured, when run on a computer to carry out methods for managing a communication network subscription identifier that is associated with a device.

### BACKGROUND

The “Internet of Things” (IoT) refers to devices enabled for communication network connectivity, so that these devices may be remotely managed, and data collected or required by the devices may be exchanged between individual devices and between devices and application servers. Such devices, examples of which may include sensors and actuators, are often, although not necessarily, subject to severe limitations on processing power, storage capacity, energy supply, device complexity and/or network connectivity, imposed by their operating environment or situation, and may consequently be referred to as constrained devices.

Mobile communication networks are increasingly used by IoT devices, and continuing dramatic increase in the use of these devices for a wide range of services is expected in the coming years. One obstacle to this growth in the use of IoT devices is the cost of the devices, and in particular the cost of the Universal Integrated Circuit Card (UICC) and embedded UICC (eUICC) technologies that are used to hold and protect subscriber credentials. These credentials are used in the authentication process that enables access to a mobile network. The cost of such technologies is almost on par with the cost of the modem of the IoT device.

Implementing Subscriber Identification Module (SIM) functionality through UICC and eUICC technologies is thus prohibitively expensive in the context of realizing a vision of several tens of billions of mobile connected devices in the near future. Alternative solutions to the UICC and eUICC have been proposed to address this cost issue. Such solutions include integrated UICC (iUICC) and Machine Communication Identity Module (MCIM). These solutions would lower cost significantly by implementing the SIM functions in circuitry that is integrated in the device modem or main processing chip. While addressing the cost issues associated with UICC and eUICC, the iUICC and MCIM offer lower strength subscription protection owing to their tightly integrated nature. It is very difficult, if not impossible, to fully apply strict security assurance procedures like Common Criteria in iUICC and MCIM, as it is very hard to have the circuitry for the SIM functions fully isolated from the rest of the chip. A strict security assurance for the whole chip would be an insurmountably difficult task that would also be extremely costly.

When using tightly integrated SIM solutions, there is therefore an increased risk of subscription fraud that could arise from credentials being exfiltrated from a device and cloned into another device. An additional complication for device owners when considering subscription fraud prevention is that device testing, device repair and management of broken devices all require a degree of control over which subscription identifiers are used in test and replacement devices.

US 20110014939 discloses a method for detection of subscription fraud on the basis of location information in a local network. However, location information may not be sufficient to detect fraudulent use of credentials in all use cases, and in addition, the method of US 20110014939 fails to account for situations in which a device may be roaming, and so connected to a visited network as opposed to its home network.

### SUMMARY

It is an aim of the present disclosure to provide a system, methods, nodes and computer readable medium which at least partially address one or more of the challenges discussed above. It is a further aim of the present disclosure to provide a system, methods, nodes and computer readable medium which cooperate to ensure that cloned subscription credentials may not be used to obtain network access authentication.

According to a first aspect of the present disclosure, there is provided a system for managing a communication network subscription identifier associated with a device. The system comprises a Core Network node configured to provide a subscription identifier for the device to a Device Management node with management responsibility for the device and a Verification node configured to receive from the Device Management node the subscription identifier and a characteristic of the device, and to bind the subscription identifier to the characteristic such that the subscription identifier is uniquely associated with the characteristic. The system further comprises a Network Access node configured to obtain the subscription identifier from the device. The Verification node, Network Access node and Core Network node are configured to cooperate to verify that the device from which the Network Access node obtained the subscription identifier is in possession of the characteristic that is bound to the subscription identifier.

According to another aspect of the present disclosure, there is provided a method for managing a communication network subscription identifier associated with a device. The method, performed by a Verification node, comprises receiving, from a Device Management node with management responsibility for the device, a subscription identifier for the device and a characteristic of the device, binding the subscription identifier to the characteristic such that the subscription identifier is uniquely associated with the characteristic, and storing the bound subscription identifier and characteristic in a memory.

According to another aspect of the present disclosure, there is provided a method for verifying a communication network subscription identifier associated with a device. The method, performed by the device, comprises receiving a parameter from a Network Access node, generating, on the basis of the received parameter, a parameter for sending to the Network Access node, and sending the generated parameter to the Network Access node. The method further comprises performing a cryptographic calculation on at least one of the received parameter or the generated parameter using a characteristic of the device, wherein the characteristic of the device has been bound to a subscription identity associated with the device such that the subscription identifier is uniquely associated with the characteristic.

According to another aspect of the present disclosure, there is provided a method for verifying a communication network subscription identifier associated with a device. The method, performed by a Network Access node, comprises sending a verification request to a Network node, the verification request comprising a subscription identifier presented by the device, and receiving a response from the Network node, the response comprising at least one of: a device characteristic that has been bound to the subscription identifier presented by the device such that the subscription identifier is uniquely associated with the characteristic, a parameter on which a cryptographic calculation has been performed using such a characteristic, or an identification of a Verification node from which either the device characteristic or parameter may be obtained. The method further comprises sending a parameter to the device, receiving a parameter from the device, and checking that the received parameter matches an expected received parameter for the device. At least one of the parameter sent to the device or the parameter received from the device comprises a parameter on which a cryptographic calculation has been performed using a device characteristic that has been bound to the subscription identifier presented by the device such that the subscription identifier is uniquely associated with the characteristic.

According to another aspect of the present disclosure, there is provided a method for verifying a communication network subscription identifier associated with a device. The method, performed by a Core Network node, comprises receiving a verification request from a Network Access node, the verification request comprising a subscription identifier presented by the device, and sending a response to the Network Access node, the response comprising at least one of: a device characteristic that has been bound to the subscription identifier presented by the device such that the subscription identifier is uniquely associated with the characteristic, a parameter on which a cryptographic calculation has been performed using such a characteristic, or an identification of a Verification node from which either the device characteristic or parameter may be obtained.

According to another aspect of the present disclosure, there is provided a method for verifying a communication network subscription identifier associated with a device. The method, performed by a Verification node, comprises receiving a verification request from a Network node, the verification request comprising a subscription identifier presented by the device and retrieving from a memory a device characteristic that has been bound to the subscription identifier presented by the device such that the subscription identifier is uniquely associated with the characteristic. The method further comprises sending a response to the Network node, the response comprising at least one of: the retrieved device characteristic, or a parameter on which a cryptographic calculation has been performed using the retrieved characteristic.

According to another aspect of the present disclosure, there is provided a method for verifying a communication network subscription identifier associated with a device.

The method, performed by a Verification node, comprises receiving, from a Network Access node, information about a characteristic of the device and a subscription identifier presented by the device and comparing the received information about a characteristic to a device characteristic that has been bound to the subscription identifier presented by the device such that the subscription identifier is uniquely associated with the characteristic. The method further comprises, responsive to a request for a result of the comparison, sending a result of the comparison to at least one of the Network Access node, a Core Network node, and/or a Device Connection Service.

According to another aspect of the present disclosure, there is provided a computer program and a computer program product configured, when run on a computer to carry out methods for managing and/or verifying a communication network subscription identifier that is associated with a device as set out above.

According to another aspect of the present disclosure, there is provided a Verification node, Device, Network Access node and Core Network node, the nodes comprising processing circuitry configured to carry out methods for managing and/or verifying a communication network subscription identifier that is associated with a device as set out above.

### BRIEF DESCRIPTION OF THE DRAWINGS

For a better understanding of the present disclosure, and to show more clearly how it may be carried into effect, reference will now be made, by way of example, to the following drawings in which:

FIG. 1 illustrates an overview of a network architecture within which the system, methods and nodes of the present disclosure may be deployed;

FIG. 2 is a block diagram illustrating functional elements within a system 200 for managing a communication network subscription identifier associated with a device;

FIG. 3 is a flow chart illustrating process steps in a method for managing a communication network subscription identifier associated with a device;

FIG. 4 is a flow chart illustrating process steps in another example of method for managing a communication network subscription identifier associated with a device;

FIGS. 5 to 10 are flow charts illustrating process steps in method for verifying a communication network subscription identifier associated with a device;

FIG. 11 is a flow chart illustrating process steps in another example of method for managing a communication network subscription identifier associated with a device;

FIGS. 12 to 14 are message flow diagrams illustrating different ways in which the methods of FIGS. 3 to 11 may be implemented; and

FIGS. 15 to 26 are block diagrams illustrating function modules in different examples of Verification node, Device, Network Access node, Core Network Node and Device Management node.

### DETAILED DESCRIPTION

Aspects of the present disclosure propose a system, methods and nodes that may cooperate to detect that cloned credentials are being used in an attempt to access a communication network, and consequently may prevent a device seeking to use such credentials from accessing the network. Aspects of the present disclosure propose binding a subscription identifier to a characteristic of a device with which the identifier is to be used, such that the subscription identifier is uniquely associated with the device characteristic. When the subscription identifier is presented by a device seeking network access, the binding between subscription identifier and device characteristic may be verified to ensure that the device presenting the subscription identifier is in possession of the characteristic to which the subscription identifier is bound. The nature of the device characteristic to which a subscription identifier is bound may vary according to different examples of the present disclosure. Two categories of device characteristic are proposed in the present disclosure: behavioural characteristics and permanent identities.

IoT devices are life-cycle managed through some form of Device Management system. In addition to collecting application related data (e.g. sensor data) the Device Management system manages Software updates to correct bugs or address security vulnerabilities. In order to secure the link between the device and the Device Management system, and to enable a user to claim and maintain ownership of the device, IoT devices are often equipped with a device identity that is permanent and independent of a mobile network to which the device may connect, and consequently independent of the operator of such a network. The permanent device identity comprises a permanent device identifier (PDI) and at least one associated credential. A permanent device identity of this nature may be distinguished from a subscription identity, which comprises a subscription identifier such as an International Mobile Subscriber Identity (IMSI), which is assigned by a communication network to subscribers to the network. The permanent device identity is not used for network access authentication, and remains unchanged even if a subscription identity (including a subscription identifier) for the device is updated, for example if the device is to be connected to another network owned by another MNO. Permanent device identities are used by the Device Management system for identifying individual devices, even if the device management system may also be aware of and make use of a subscription identifier allocated to a device. Permanent device identities lend themselves much more readily to strong protection against exfiltration of the identity credentials which may be comprised in the identity. Cloning of a permanent device identity may therefore be considered to be practically infeasible.

According to one example of the present disclosure, during a phase in which a device is registered in a device management system, and a subscription is arranged for the device, a permanent device identity may be bound to a subscription identifier for the device, such as an IMSI, and may also be bound to use or behavioural characteristics including mobile network cell information, and network functions that the device owner wishes the device to have. The permanent device identity is bound to the subscription identifier via its component permanent device identifier. As the permanent device identity is for all practical purposes not cloneable, and is bound (via its identifier) to the subscription identifier associated with the device, it is possible to check this binding before, during or after authentication by a network authentication agent. This check may discover that the binding is correct, or that the binding is incorrect, or that during network registration the same IMSI appears again but with a different permanent device identifier bound to it. Such a “re-binding” may be blocked or may trigger a fraud alarm that blocks network access until proper authorisation is established and the previous registered device management owner confirms the rebinding is correct and the device should be allowed to access the network.

In some circumstances, a device may not be provided with a permanent device identity but only a device identifier, which may be permanent or non-permanent. Some mobile devices, for example, are only provided with an International Mobile Equipment Identity (IMEI), which can be changed or cloned and so is not a basis for a secure binding between device and subscription identity. In such circumstances, it may be desirable to use a behavioural device characteristic for binding to the subscription identifier assigned to a device. The behavioural characteristic may be provided by a Device Connection Service (DCS) when the device is registered. The behavioural characteristic may for example include information, provided by the device owner (or in some cases the manufacturer of the device), about how the device connects to the network. Such information may, for example, be obtained from a Manufacturer Usage Description (MUD). This behaviour may then be observed by the DCS when the device connects to the network and/or during registration, in order to enable a comparison with the behaviour characteristic bound to the subscriber identifier presented by the device. For example, a device owner can indicate that a device is a stationary device such as a temperature sensor or a pump valve controller, in which case the DCS can record the network cell number and other network characteristics for binding to the subscriber identifier assigned to the device. In further examples, a behavioural characteristic may also encompass environmental factors, which may in some examples be linked to location, including altitude, temperature, electricity, land air and/or underwater deployments etc. Any such factors may be provided on registration of a device and observed when the device connects to the network.

When a device connects to a communication network, the DCS may observe the network characteristics of the connecting device and pass this to a Verification Node for comparison with the behavioural characteristic bound to the subscription identifier presented by the device. The Verification Node is a new functional service entity, which may be implemented on a physical or virtual node and may in some examples be co-located with one or more other services. The Verification node compares an observed behavioural characteristic from the DCS with a stored behavioural characteristic that is bound to the subscription identifier presented by the device, and performs an analysis to determine whether the connectivity is normal (observed and bound behavioural characteristics are consistent) or is potentially fraudulent (mismatch between the observed and bound behavioural characteristics). If a potential fraud is detected, the Verification node may push an alarm condition to a Network Access node, such as a Network Access Authentication Function (NAAF). Alternatively a Network Access node such as a NAAF may pull a verification result from the Verification node when it performs network access verification.

In some circumstances, the Network Access node for a particular device may be in a visited network, for example as a visited network Mobility Management Entity (MME) in a 4G network. In such circumstances, only the home network knows that a presented subscription identifier is associated with a device for which a Verification node service is available. To inform the Network Access node, the home network, for example a Core Network node such as a Home Subscription Server (HSS), may push a Unique Resource Identifier (URI) of the appropriate Verification node to the visiting network. The URI may be included with the authentication information that the home network pushes to the visited network under existing attach procedures. In other examples, for example in which a behavioural characteristic is bound to a subscription identifier, the DCS may have connection information that will be used for verification of a binding. In such examples, the home network (for example a Core Network node such as a HSS) may contact the DCS and pull connection information for provision to the Verification node to allow the Verification node to perform a binding check. If the binding check is unable to confirm that the device is in possession of a bound characteristic, the visiting network may be informed using standard network procedures that access should not be granted.

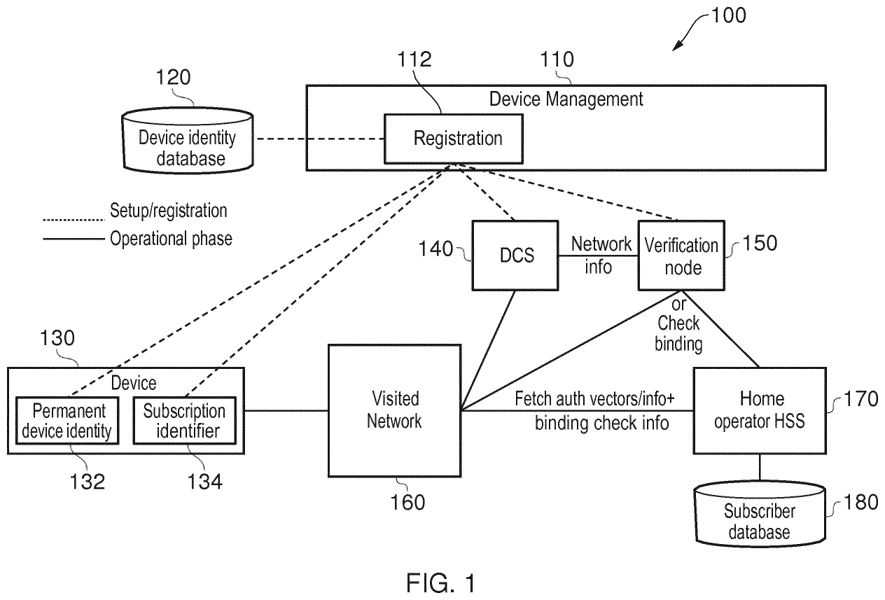

FIG. 1 illustrates an overview of a network architecture 100 within which the system, methods and nodes of the present disclosure may be deployed. It will be appreciated that while the architecture 100 of FIG. 1 is described below as comprising a plurality of nodes, any one or more of these nodes may comprise one or more physical and or virtual nodes, and may be combined with one or more other nodes. The functionality of the nodes may be implemented in any suitable physical or virtual architecture, such that the connectivity between the functions illustrated in FIG. 1 is maintained.

Referring to FIG. 1, the network architecture includes a Device Management (DM) node 110, within which is implemented a Registration function 112. The Registration function 112 of the DM node 110 is in communication with a Device identity database 120. The architecture 100 further comprises a device 130, within which may be stored a permanent device identity 132, comprising a permanent device identifier and at least one credential, and subscription identifier 134. The permanent device identifier is associated with the at least one credential that also forms part of the permanent device identity 132. The subscription identifier may also be associated with at least one credential. The architecture 100 further comprises a Visited network 160, within which may be configured a Network Access Node, and a Home network Home Subscription Server (HSS) 170 in communication with a subscriber database 180. The HSS is an example of a Core Network node. The architecture 100 further comprises a Device Connection Service node 140 and a Verification node 150. The dashed lines between nodes in the architecture 100 of FIG. 1 represent message exchanges between the nodes during a setup or registration phase according to examples of the present disclosure. The solid lines between nodes represent message exchanges between the nodes during an operational phase according to examples of the present disclosure.

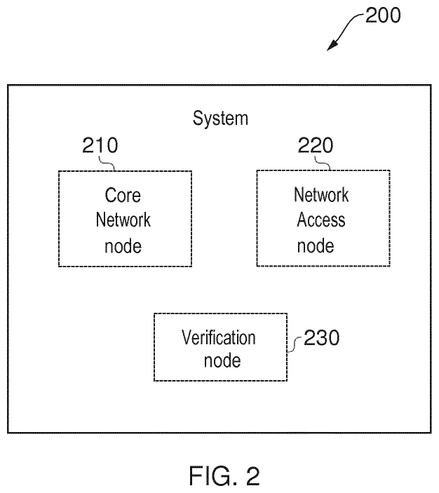

FIG. 2 is a block diagram illustrating functional elements within a system 200 for managing a communication network subscription identifier associated with a device in accordance with examples of the present disclosure. It will be appreciated from the following discussion that the system 200 may comprise one or more elements of the architecture 100 described above. Referring to FIG. 2, the system 200 comprises a Core Network node 210 configured to provide a subscription identifier for the device to a Device Management node with management responsibility for the device. The system further comprises a Verification node 230 configured to receive from the Device Management node the subscription identifier and a characteristic of the device, and to bind the subscription identifier to the characteristic such that the subscription identifier is uniquely associated with the characteristic. The system 200 further comprises a Network Access node 220 configured to obtain the subscription identifier from the device. The Verification node 230, Network Access node 220 and Core Network node 210 are configured to cooperate to verify that the device from which the Network Access node obtained the subscription identifier is in possession of the characteristic that is bound to the subscription identifier. The system 200 may further comprise a Device Management node (not shown), which may be configured to receive a subscription identifier for the device from the Core Network node and to provide the subscription identifier and a characteristic of the device to the Verification node. The Device Management node may be further configured to exchange a Device Management key with the Verification node and the Core Network node, and to approve binding of a characteristic to a subscription identifier using a signature.

According to examples of the present disclosure, the Core Network node may comprise a Home Subscription Server (HSS) in a 4G network, or the appropriate functionality of an Authentication Server Function (AUSF) or Unified Data Management (UDM) in a 5G network. The Verification node may comprise a new functional entity providing verification services as discussed above and in greater detail below. According to examples of the present disclosure, the Network Access node may comprise a Network Access Authentication Function (NAAF), Mobility Management Entity (MME) or Access Management Function (AMF), and may be located in a home or visited network. It will be appreciated that the nodes of the system 200 comprise functional entities that may be deployed on one or more physical or virtual nodes.

The nodes of the system 200 cooperate to provide binding by the Verification node 230 of a subscription identifier to a device characteristic, and to verify that a device presenting the subscription identifier is in possession of the characteristic bound to the identifier. As noted above, binding a characteristic to a subscription identifier comprises creating a unique association between these two elements. In some examples, the unique association may be immutable. In some circumstances, it may be required to re-bind a subscription identifier to a new device characteristic, for example in the event of testing of different devices with the same IMSI, replacement of a broken device with the same IMSI, subscription transfer between devices, etc. In such circumstances, the immutable nature of the binding between subscription identifier and device characteristic means that such a “re-binding” is in fact the creation of a new association for the subscription identity, which may be approved by the Device Management node through a signature, and not an updating of an existing binding. This distinction is discussed in greater detail below.

In some examples of the present disclosure, the Verification node 230, Network Access node 220 and Core Network node 210 may be configured to cooperate to verify that the device from which the Network Access node 220 obtained the subscription identifier is in possession of the characteristic that is bound to the subscription identifier by performing at least one of:
1) obtaining an observed characteristic of the device and comparing the observed characteristic to the characteristic that is bound to the subscription identifier, or
2) performing a cryptographic calculation using the characteristic that is bound to the subscription identifier, causing the device to perform a corresponding cryptographic calculation using a characteristic in its possession, and using the results of the cryptographic calculations to verify that the characteristic that is bound to the subscription identifier is the same as the characteristic that is in the possession of the device.

In some examples of the present disclosure, the Verification node 230, Network Access node 220 and Core Network node 210 may be configured to perform a cryptographic calculation using the characteristic that is bound to the subscription identifier, cause the device to perform a corresponding cryptographic calculation using a characteristic in its possession, and use the results of the cryptographic calculations to verify that the characteristic that is bound to the subscription identifier is the same as the characteristic that is in the possession of the device during a network authentication procedure for the device. In further examples, the performance and use of the cryptographic calculations may take place before or after a network authentication procedure.

In some examples of the present disclosure, the device that is in possession of a characteristic and presenting a subscription identifier may be a constrained device. For the purposes of the present disclosure, a constrained device comprises a device which conforms to the definition set out in section 2.1 of IETF RFC 7228 for “constrained node”. According to the definition in IETF RFC 7228, a constrained device is a device in which “some of the characteristics that are otherwise pretty much taken for granted for Internet nodes at the time of writing are not attainable, often due to cost constraints and/or physical constraints on characteristics such as size, weight, and available power and energy. The tight limits on power, memory, and processing resources lead to hard upper bounds on state, code space, and processing cycles, making optimization of energy and network bandwidth usage a dominating consideration in all design requirements. Also, some layer-2 services such as full connectivity and broadcast/multicast may be lacking”. Constrained devices are thus clearly distinguished from server systems, desktop, laptop or tablet computers and powerful mobile devices such as smartphones. A constrained device may for example comprise a Machine Type Communication device, a battery powered device or any other device having the above discussed limitations. Examples of constrained devices may include sensors measuring temperature, humidity and gas content, for example within a room or while goods are transported and stored, motion sensors for controlling light bulbs, sensors measuring light that can be used to control shutters, heart rate monitors and other sensors for personal health (continuous monitoring of blood pressure etc.) actuators and connected electronic door locks. IoT devices may comprise examples of constrained devices. Examples of the present disclosure may provide particular advantages when implemented in connection with constrained devices, owing to the trend in such devices toward integration of SIM function circuitry into a main processing chip and the security risks associated with such integration, as discussed in greater detail above.

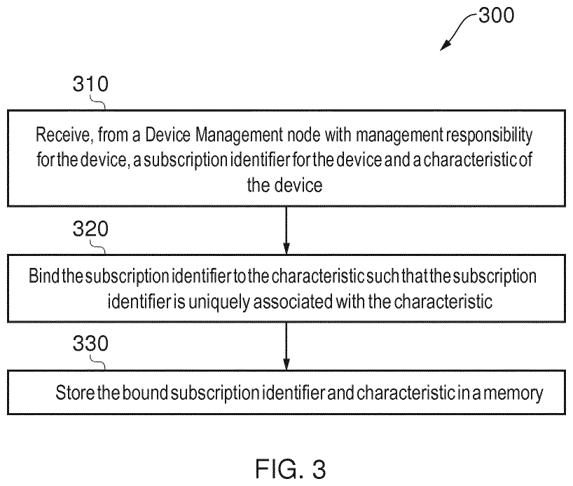

It will be appreciated that the system 200 described above comprises a plurality of different nodes, each of which performs respective method steps in order to carry out the cooperation that achieves the above discussed functionality. FIGS. 3 to 11 are flow charts illustrating process steps in methods that may be carried out at individual nodes according to different examples of the present disclosure. As mentioned above, each of the nodes carrying out the methods comprises a functional entity that may be deployed on one or more physical or virtual nodes.

FIG. 3 is a flow chart illustrating process steps in a method 300 for managing a communication network subscription identifier associated with a device, which may be a constrained device as discussed above. The method 300 is performed by a Verification node. With reference to FIG. 3, the method 300 comprises receiving, from a Device Management node with management responsibility for the device, a subscription identifier for the device and a characteristic of the device in step 310. The method 300 further comprises, in step 320, binding the subscription identifier to the characteristic such that the subscription identifier is uniquely associated with the characteristic, and, in step 330, storing the bound subscription identifier and characteristic in a memory.

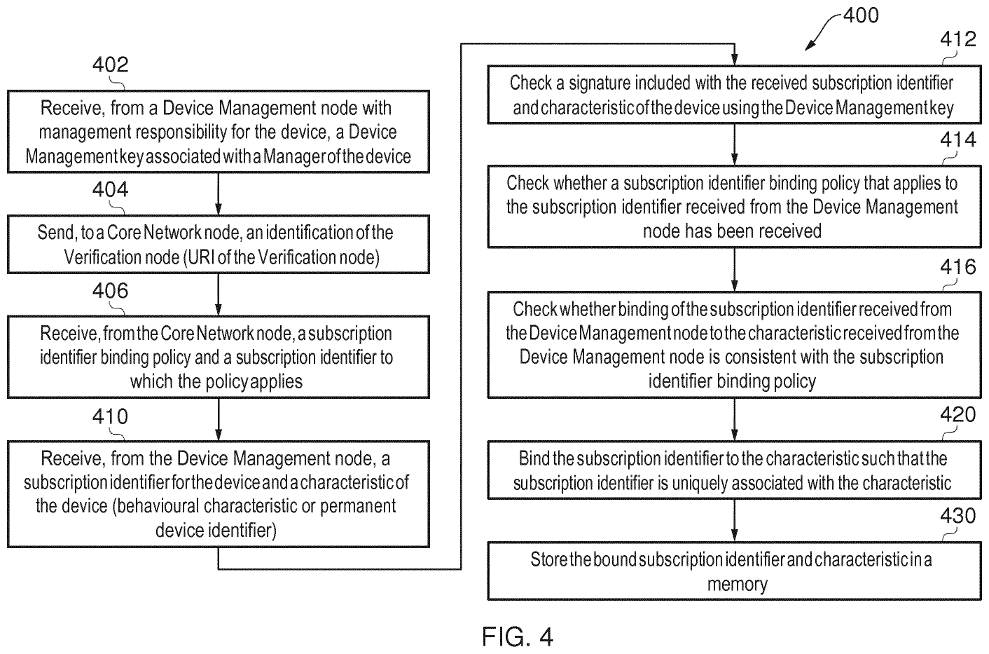

FIG. 4 is a flow chart illustrating process steps in another example of method 400, performed by a Verification node, for managing a communication network subscription identifier associated with a device, which may be a constrained device as discussed above. The steps of the method 400 illustrate one example way in which the steps of the method 300 may be implemented and supplemented in order to achieve the above discussed and additional functionality.

Referring to FIG. 4, according to the method 400, the Verification node carrying out the method first receives, in step 402, a Device Management key associated with a Manager of the device. The Device Management key may be received, as illustrated in FIG. 4, directly from a Device Management node with management responsibility for the device. In such examples, the Device management key may be received in the form of a certificate, and one or more trusted Certification Authorities (CAs) may have been configured which the received certificate must chain to in order for the Device Management Key to be trusted by the Verification node. In other examples, some registration and/or configuration may be performed by a trusted party relating to what key(s) are to be trusted by the Verification node.

Referring still to FIG. 4, the Verification node then sends, to a Core Network node at step 404, an identification of the Verification node, wherein the identification comprises a Uniform Resource Identifier (URI) of the Verification node. The identifier of the Verification node may further comprise a certificate (for example a Transport Layer Security (TLS) certificate) of the Verification node.

In step 406, the Verification node receives, from a Core Network node, a subscription identifier binding policy and a subscription identifier to which the policy applies. The binding policy may specify under what circumstances a new binding may be created for a subscription identifier, or conditions that must be fulfilled for a binding to take place (certificate or signature required etc.).

In step 410, the Verification node receives, from the Device Management node with management responsibility for the device, a subscription identifier for the device and a characteristic of the device. The characteristic of the device received from the Device Management node may comprise at least one of a behavioural characteristic or a permanent device identity.

A behavioural characteristic may for example include information, provided by the device owner, about how the device connects to the network. For example, a device owner can indicate that a device is a stationary device and a behavioural characteristic for the device may include information about a location from which the device is expected to connect, such as mobile network cell information. A behavioural characteristic may additionally or alternatively include network functions that the device owner wishes the device to have, or any other information relating to how the device connects to and interacts with the network. The behavioural characteristic may then be observed by a Device Connection Service (DCS) for comparison with a bound behavioural characteristic.

A permanent device identity, as discussed above, comprises a permanent device identifier and a credential. A permanent device identity is independent of a mobile network to which the device may connect, and consequently is independent of the operator of such a network. A permanent device identity, and its constituent permanent device identifier, may thus be distinguished from a subscription identifier, such as an International Mobile Subscriber Identity (IMSI), which is assigned by a communication network to subscribers to the network. Permanent device identities are used by a device management system for identifying individual devices, even if the device management system may also be aware of and make use of a subscription identifier allocated to a device. A credential that is part of a permanent device identity, and therefore associated with the corresponding permanent device identifier, may in some examples comprise a device specific public key associated with a corresponding device specific private key, or may be a device specific symmetric key.

Referring still to FIG. 4, after receiving a subscription identifier and characteristic of the device from the Device Management node in step 410, the Verification node then checks, at step 412, a signature included with the received subscription identifier and characteristic of the device using the Device Management key received in step 402. In step 414, the Verification node also checks whether a subscription identifier binding policy that applies to the subscription identifier received from the Device Management node has been received in step 406. If such a subscription identifier binding policy has been received, the Verification node checks, in step 416, whether binding of the subscription identifier received from the Device Management node to the characteristic received from the Device Management node is consistent with the subscription identifier binding policy.

If binding of the subscription identifier received from the Device Management node to the characteristic received from the Device Management node is consistent with the subscription identifier binding policy, the Verification node proceeds, in step 420, to bind the subscription identifier to the characteristic such that the subscription identifier is uniquely associated with the characteristic. In step 430, the Verification node stores the bound subscription identifier and characteristic in a memory. In the case of a characteristic comprising a permanent device identity, the Verification node may bind the permanent device identity to the subscription identifier using the permanent device identifier part of the permanent device identity. In this manner, the permanent device identifier is explicitly bound to the subscription identifier, and via this binding, the entire permanent device identity, including the credential that is also part of the permanent device identity and is associated with the permanent device identifier, is also bound to the subscription identifier.

The steps of the methods 300 and/or 400 thus enable a Verification node to bind a subscription identifier assigned to a device by a Core Network node of a communication network to a characteristic of the device. The binding may be subject to various checks to ensure that the binding should go ahead, and creates a unique association between the subscription identifier and the characteristic, which association may be immutable. In some examples, the association may be a new association for a subscription identifier that has already been bound to a different device characteristic in the past. This situation is referred to as a “re-binding”, and may be subject to additional restrictions set out in a subscription identifier binding policy or imposed directly through a confirmatory check with a mobile network operator via a Core Network node or with a Device Management node.

The methods 300 and/or 400 may be complimented by methods carried out at a device, a Network Access node, a Core Network node a Device Management node and the Verification node, in order to verify that a device presenting a subscription identifier is in possession of the device characteristic to which the identifier has been bound by the Verification node. This is discussed in further detail below.

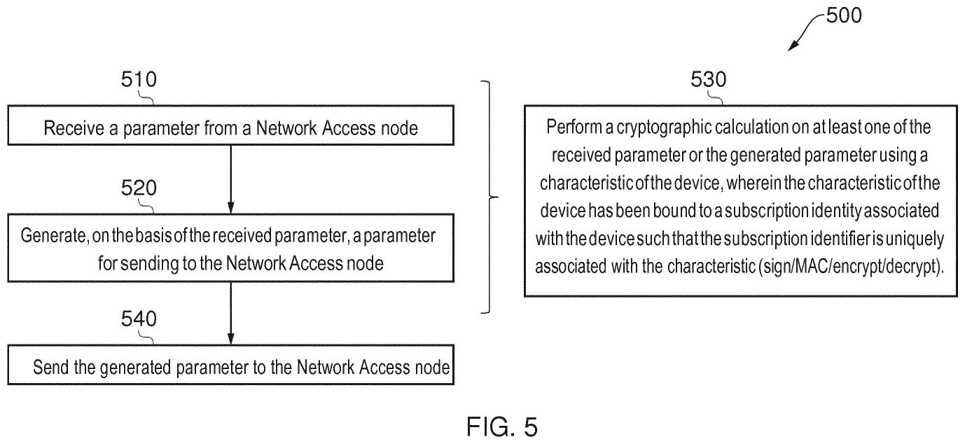

FIG. 5 is a flow chart illustrating process steps in a method 500 for verifying a communication network subscription identifier associated with a device. The method is performed by the device and comprises, in a first step 510, receiving a parameter from a Network Access node. The received parameter may for example be a RAND value received as part of an Authentication and Key Agreement (AKA) procedure, an Extensible Authentication Procedure (EAP)-AKA procedure, or an EAP-AKA′ procedure, or may be a random value received as part of a post authentication challenge. In step 520, the device generates, on the basis of the received parameter, a parameter for sending to the Network Access node. The generated parameter may be the received challenge parameter, to be returned with a signature or Message Authentication Code (MAC), or may be a RES parameter generated as part of an AKA, EAP-AKA or EAP-AKA' procedure. In step 540, the device sends the generated parameter to the Network Access node.

The method 500 further comprises the device performing, at step 530, a cryptographic calculation on at least one of the received parameter or the generated parameter using a characteristic of the device, wherein the characteristic of the device has been bound to a subscription identity associated with the device such that the subscription identifier is uniquely associated with the characteristic. The device characteristic may for example comprise a permanent device identity, bound via a permeant device identifier of the permanent device identity, as discussed above. The cryptographic calculation may be performed using the credential of the permanent device identity, which may comprise a public and private key pair or a symmetric key.

According to different examples of the present disclosure, performing a cryptographic calculation on at least one of the received parameter or the generated parameter using a characteristic of the device may comprise any one or more of:
1) signing at least one of the received parameter or the generated parameter using the characteristic;
2) generating a MAC for at least one of the received parameter or the generated parameter using the characteristic;
3) encrypting or decrypting at least one of the received parameter or the generated parameter using the characteristic.

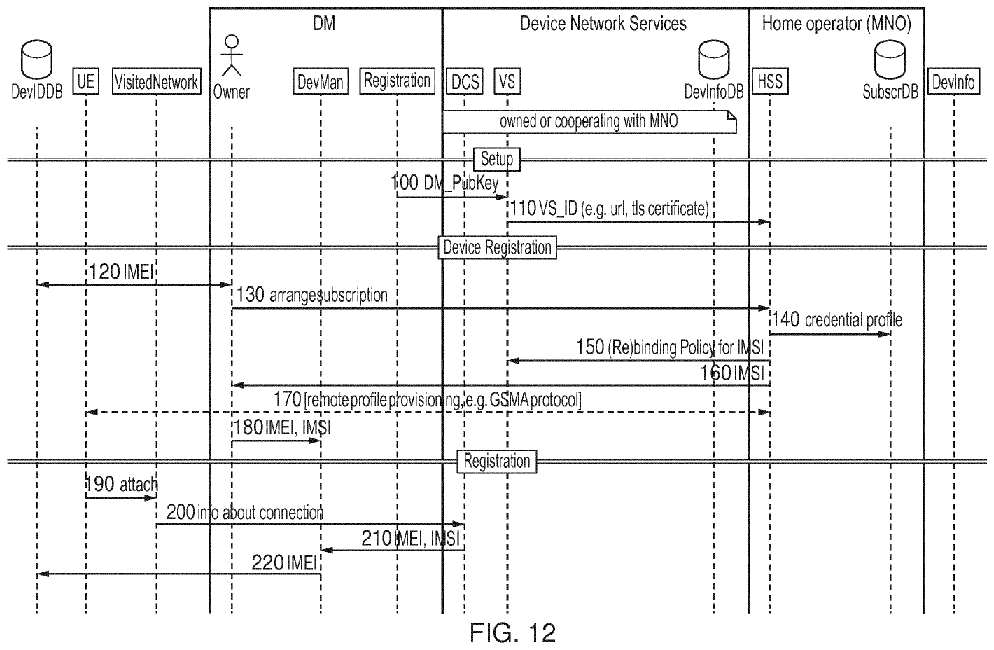

According to different examples of the present disclosure, the device may for example decrypt an encrypted RAND parameter before performing AKA, EAP-AKA or EAP-AKA′, or may encrypt a generated RES parameter before sending this to the Network Access node, or the device may sign or generate a MAC for either the RAND or RES. Example implementations of the method 500 are illustrated in the message flow diagrams in FIGS. 12 to 14 and discussed in further detail below.

According to further examples of the present disclosure, the device may additionally derive a device specific key from the device characteristic in the form of a permanent device identity. For example, the device may derive a device specific symmetric key for use in encrypting or decrypting parameters. The device specific symmetric key may be derived from a device secret (such as device private key or symmetric key part of the device identity credential) that is a component part of the permanent device identity and is associated with the permanent device identifier. In other examples, the device may use a device private key comprised in the permanent device identity and associated with the permanent device identifier to decrypt a parameter received by the device and encrypted by another entity using a corresponding device public key. In further examples of the present disclosure, the device may additionally carry out process steps of an authentication procedure such as AKA, EAP-AKA or EAP-AKA′ according to existing or future standardised procedures.

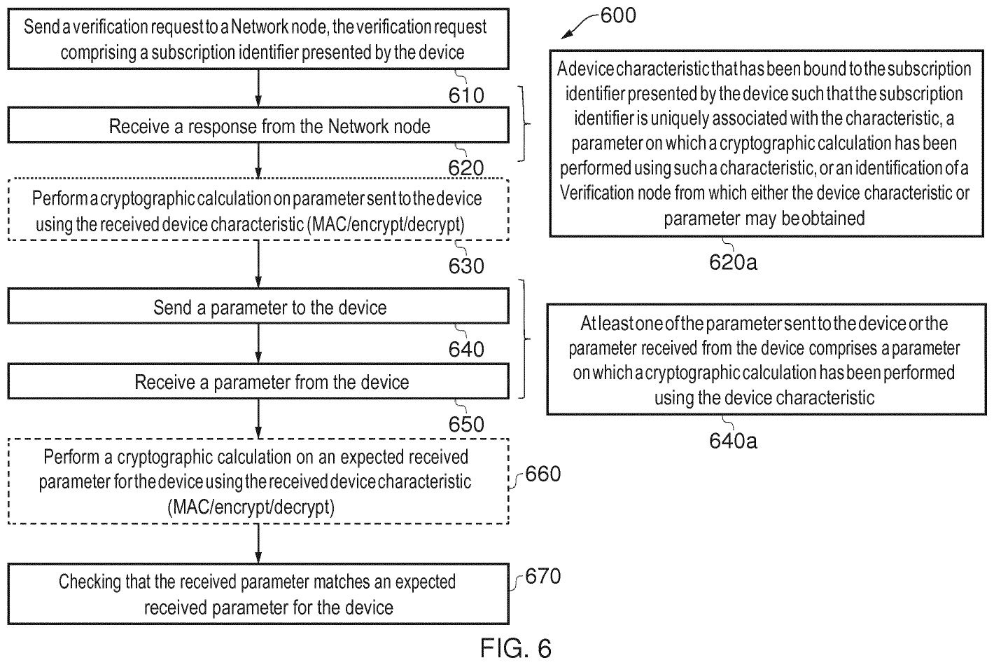

FIG. 6 is a flow chart illustrating process steps in a method 600 for verifying a communication network subscription identifier associated with a device, which may be a constrained device, as discussed above. The method 600 is performed by a Network Access node. Examples of a Network Access node may include a Network Access Authentication Function (NAAF), Mobility Management Entity (MME) or Access Management Function (AMF). The Network Access node may be located in a home or visited network.

Referring to FIG. 6, the method 600 initially comprises sending, by the Network Access node, a verification request to a Network node in step 610, the verification request comprising a subscription identifier presented by the device. The subscription identifier may for example have been presented in a request for access to the communication network sent by the device. The Network node to which the verification request is sent may comprise a Core Network node or a Verification node according to different examples of the present disclosure. In some examples, a verification request may be sent to a Core Network node and then to a Verification node, for example if the Core Network node returns only an identifier for a Verification node (option 3 below).

In step 620, the Network Access node receives a response from the Network node. As illustrated in step 620a, the response comprises at least one of:
1) a device characteristic that has been bound to the subscription identifier presented by the device such that the subscription identifier is uniquely associated with the characteristic;
2) a parameter on which a cryptographic calculation has been performed using such a characteristic; and/or
3) an identification of a Verification node from which either the device characteristic or parameter may be obtained.

In some examples, if the response comprises an identification of a Verification node from which either the device characteristic or parameter may be obtained, then the Network Access node may send a new verification request to the identified Verification node in order to obtain the device characteristic or parameter, before continuing with the method steps set out below.

In some examples, the Network node may then perform a cryptographic calculation in step 630 on at least one of a parameter to be sent to the device or an expected parameter to be received from the device, the calculation performed using the bound device characteristic received in step 620. The characteristic may for example be a permanent device identity, bound via its constituent permanent device identifier as discussed above, and the cryptographic calculation may be performed using the permanent device identifier of the permanent device identity, a device specific key derived from a device secret or credential associated with the permanent device identifier and comprised within the permanent device identity, or a device public key of a public/private key pair associated with the permanent device identifier and comprised within the permanent device identity. In the case of an implementation of the method 600 as part of an Authentication procedure, the parameter for sending to the device may be a RAND parameter and the expected parameter to be received from the device may be an XRES parameter. Performing a cryptographic calculation on a parameter using a characteristic of the device may comprise at least one of generating a MAC for the parameter using the characteristic and/or encrypting or decrypting the parameter using the characteristic. In the case of generating a MAC for the parameter using the characteristic, that MAC is then saved for comparison (in step 670) with a MAC received from the device in step 650, as discussed below.

In step 640, the Network Access node sends a parameter to the device. As discussed above, this may for example be a RAND parameter sent as part of an Authentication procedure or as a post-Authentication challenge. The parameter may in some examples have been encrypted, by the Network Access node or by another entity such as a Core Network node, using the bound device characteristic. In step 650, the Network Access node receives a parameter from the device. This may for example be a RES parameter generated by the device as part of an Authentication procedure or a response to a post-Authentication challenge. In other examples, the parameter may comprise a MAC generated by the device using the device's characteristic and based on the parameter sent by the Network Access node to the device. As illustrated in step 640a, at least one of the parameter sent to the device in step 640 or the parameter received from the device in step 650 comprises a parameter on which a cryptographic calculation has been performed using a device characteristic that has been bound to the subscription identifier presented by the device such that the subscription identifier is uniquely associated with the characteristic. The cryptographic calculation may be been performed by the Network Access node, if it has been performed on the parameter sent to the device, or by the device, if it has been performed on the parameter received from the device. As discussed above, the bound characteristic may comprise a permanent device identity, which comprises a permanent device identifier and a credential. The permanent device identity may have been bound to the subscription identifier via its permanent device identifier, and the cryptographic calculation may be performed using the credential of the permanent device identity, which credential is associated with the permanent device identifier.

In step 660, the Network Access node may perform a cryptographic calculation on the parameter received from the device using the device characteristic that has been bound to the subscription identifier presented by the device such that the subscription identifier is uniquely associated with the characteristic. As discussed above, performing a cryptographic calculation on a parameter using a characteristic of the device may comprise at least one of generating a MAC for the parameter using the characteristic and/or encrypting or decrypting the parameter using the characteristic. For example, the Network Access node may encrypt the parameter received from the device, or may decrypt the parameter received from the device. In other examples, the Network Access node may compute a MAC on the parameter received from the device and store this MAC for comparison with a received MAC in step 670.

In step 670, the Network Access node checks that the received parameter matches an expected received parameter for the device. This checking may take different forms, depending upon the nature of the parameter received from the device, and in some examples, the checking may itself comprise performing a cryptographic calculation on the received parameter, as discussed below.

In the case of a received parameter in the form of a MAC, the expected received parameter may comprise a MAC which has been received by the Network Access node from a Core Network node (such as a HSS for the device) or has been calculated by the Network Access node in step 630 or 660 and stored for use in the comparison of step 670. The received or calculated MAC may be compared with the MAC received from the device.

In the case of a received parameter in the form of a RES, or a response to a post-Authentication challenge, the expected received parameter may comprise an XRES received as part of an Authentication Vector from a Core Network node, or an expected response value corresponding to the post-Authentication challenge. The received RES or response may be compared with the XRES or expected response.

In the case of a received parameter in the form of an encrypted RES or encrypted response to a post-Authentication challenge, an expected received parameter in the form of an XRES or expected response may have been encrypted by the Network Access node in step 660. Alternatively, the XRES or expected response may have been received in encrypted form by the Network Access node form a Core Network node or Verification node. The Network Access node may then directly compare the encrypted received RES or encrypted received response with the encrypted XRES or encrypted expected response.

In the case of a received parameter in the form of a signature, checking that the received parameter matches an expected parameter in step 670 may comprise computing a hash of the signed data and decrypting the signature to retrieve an expected hash of the signed data. The public key is used that corresponds to the private key used to sign the data. Checking further comprises comparison of the computed hash with the expected hash. Thus in the example of a received parameter comprising a signature, a cryptographic calculation is performed on the parameter received from the device by both the device (in generating the signature) and the Network Access node (in verifying the signature).

As mentioned above, the Network node to which the verification request is sent in step 610 may be a Core Network node or may be a Verification node. In the case of the Core Network node, the Core Network node is a part of a communication network that has issued the subscription identifier, and the Network Access node may be a part of the same communication network or a different communication network. The Network Access node may hence be a part of a Visited network, with the Core Network node being part of the Home network for the device. If the Core Network node provides only an identification of a Verification node in response to the verification request, then the Network Access node may send a new verification request to the Verification node in order to obtain the device characteristic or parameter, before completing the method.

The method 600 may be implemented in different ways. For example, the Network Access node may receive from a Core Network node or a Verification node component elements of a permanent device identity, including for example a permanent device identifier and a device specific key, an expected MAC, an encrypted XRES, an encrypted RAND, etc. The Network Access node may send to the device a RAND or an encrypted RAND and may receive from the device a signature, a MAC, a RES, an encrypted RES etc. The nature of the check performed in step 670 may be determined by the nature of the parameters exchanged as discussed above. For example, the Network Access node may check, using the device public key, a signature generated by the device using its device private key, or may compare a MAC received from the device with a MAC received from the Network node or computed by the Network Access node in step 630 or 660. The Network Access node may alternatively compare an encrypted RES received from the device with an encrypted XRES or compare a RES received from the device with an XRES (for example if the Network Access node sent an encrypted RAND to the device). In the various different examples, the Network Access node performs some kind of comparison between a parameter received from the device and an expected value of such a parameter, and a cryptographic calculation using the bound characteristic is or has been performed on either the parameter that is sent to the device or the parameter that has been received from the device. The comparison enables the Network Access node to confirm that the device is in possession of the bound characteristic, for example because it was able to accurately decrypt an encrypted RAND and generate the correct RES, or because it has correctly encrypted RES, or correctly generated a MAC or signature.

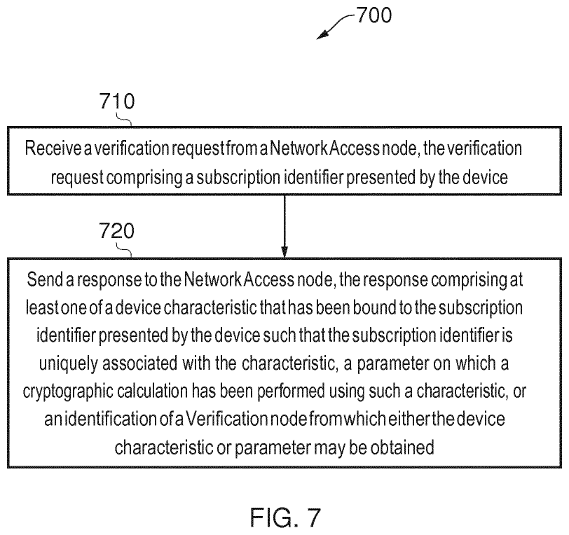

FIG. 7 is a flow chart illustrating process steps in a method 700 for verifying a communication network subscription identifier associated with a device, which may be a constrained device, as discussed above. The method 700 is performed by a Core Network node, which may for example comprise a Home Subscription Server (HSS) in a 4G network, or the appropriate functionality of an Authentication Server Function (AUSF) or Unified Data Management (UDM) in a 5G network.

Referring to FIG. 7, the method 700 comprises, in a first step 710, receiving a verification request from a Network Access node, the verification request comprising a subscription identifier presented by the device. In step 720, the method comprises sending a response to the Network Access node, the response comprising at least one of:
1) a device characteristic that has been bound to the subscription identifier presented by the device such that the subscription identifier is uniquely associated with the characteristic;
2) a parameter on which a cryptographic calculation has been performed using such a characteristic, and/or
3) an identification of a Verification node from which either the device characteristic or parameter may be obtained.

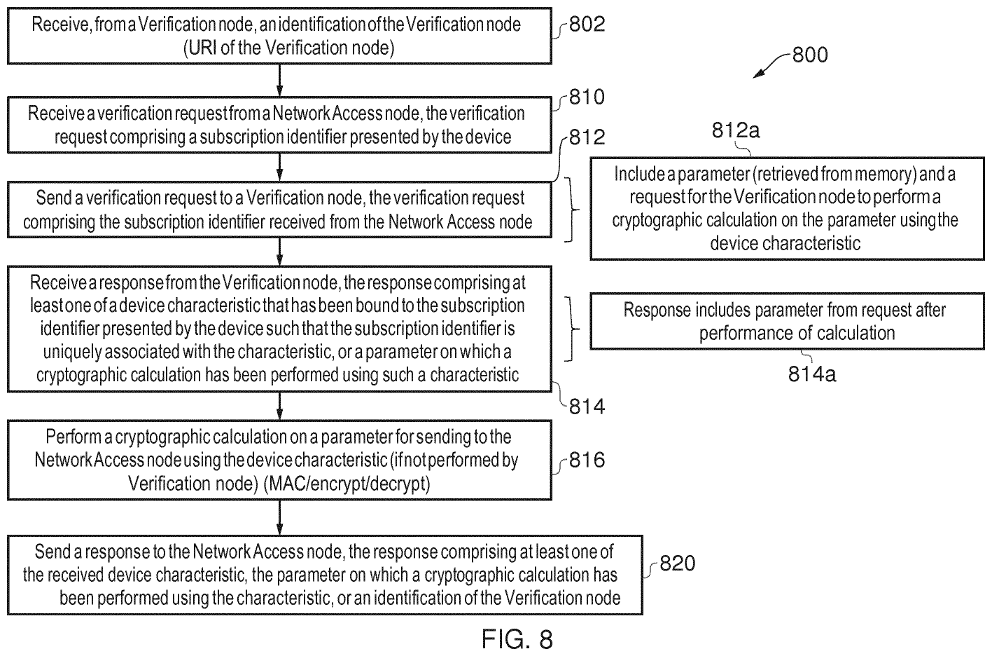

FIG. 8 is a flow chart illustrating process steps in another example of method 800, performed by a Core Network node, for verifying a communication network subscription identifier associated with a device, which may be a constrained device as discussed above. The steps of the method 800 illustrate one example way in which the steps of the method 700 may be implemented and supplemented in order to achieve the above discussed and additional functionality.

Referring to FIG. 8, according to the method 800, the Core Network node carrying out the method first receives in step 802, from a Verification node, an identification of the Verification node, wherein the identification comprises a Uniform Resource Identifier (URI) of the Verification node. The Verification node from which the URI is received may be under the control of the same communication network to which the Core Network node belongs. In step 810, the Core Network node receives a verification request from a Network Access node, the verification request comprising a subscription identifier presented by the device. The Network Access node may be in the same communication network as the Core Network node or may be in a different communication network.

In step 812, the Core Network node may send a verification request to a Verification node, the verification request comprising the subscription identifier received from the Network Access node. As illustrated at 812a, the verification request sent to the Verification node may further comprise a parameter (for example retrieved from a memory) and a request for the Verification node to perform a cryptographic calculation on the parameter using the device characteristic that has been bound to the subscription identifier presented by the device such that the subscription identifier is uniquely associated with the characteristic. The parameter may for example be a parameter for inclusion in an Authentication Vector (AV) for the device, such as a RAND or XRES parameter.

In step 814, the Core Network node may receive a response from the Verification node, the response comprising at least one of:
1) a device characteristic that has been bound to the subscription identifier presented by the device such that the subscription identifier is uniquely associated with the characteristic; and/or
2) a parameter on which a cryptographic calculation has been performed using such a characteristic. This may be the parameter included in the verification request sent to the Verification node, as illustrated at step 814a.

The device characteristic bound to the subscription identifier may comprise component elements of a permanent device identity, including for example a permanent device identifier and a device specific key. The device specific key may be a device specific public key which is associated with a corresponding device specific private key, or may be a device specific symmetric key. The permanent device identity may be bound to the subscription identifier via its constituent permanent device identifier.

In step 816, the Core Network node may perform a cryptographic calculation on a parameter for sending to the Network Access node using the device characteristic that has been bound to the subscription identifier presented by the device such that the subscription identifier is uniquely associated with the characteristic. The cryptographic calculation may for example be performed using the device specific key of the permanent device identity. This may be the case for example if the Verification node has returned the device characteristic rather than a parameter on which a cryptographic calculation has already been performed. As discussed above, performing a cryptographic calculation on a parameter using a characteristic of the device may comprise at least one of generating a MAC for the parameter using the characteristic and/or encrypting or decrypting the parameter using the characteristic.

As mentioned above, the parameter on which a cryptographic calculation is performed (by the Verification node or the Core Network node) may be retrieved by the Core Network node from a memory as being associated with the subscriber identifier presented by the device. Thus in an authentication procedure, the Core Network node may retrieve an appropriate RAND, XRES etc. for populating an Authentication Vector, and may then either encrypt such a parameter or calculate a MAC for such a parameter using a device characteristic returned by the Verification node, or may request this operation be performed by the Verification node, before sending the parameter to the Network Access node.

In step 820, the Core Network node sends a response to the Network Access node, the response comprising at least one of:
1) a device characteristic that has been bound to the subscription identifier presented by the device such that the subscription identifier is uniquely associated with the characteristic;
2) a parameter on which a cryptographic calculation has been performed using such a characteristic; and/or
3) an identification of a Verification node from which either the device characteristic or parameter may be obtained.

The identification of the Verification node from which either the device characteristic or parameter may be obtained may comprise a URI of the Verification node, which may be a URI received from the Verification node in step 802.

It will be appreciated that the performance of steps 802 and/or 812 to 816 may be dependent upon a particular implementation of the method. For example, if the Core Network node is configured to send an identification of a Verification node in the response at step 820, then the Core Network node may omit one or more of steps 812 to 816.

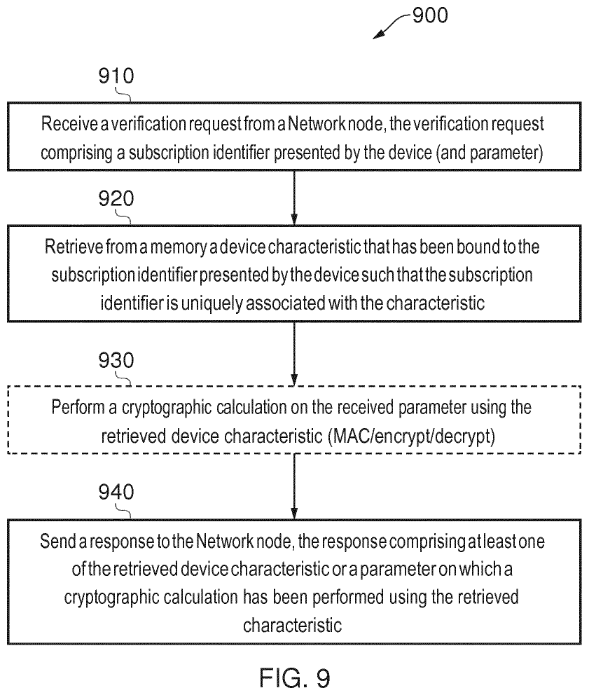

FIG. 9 is a flow chart illustrating process steps in a method 900 for verifying a communication network subscription identifier associated with a device. The method is performed by a Verification node and comprises, in a first step 910, receiving a verification request from a Network node, the verification request comprising a subscription identifier presented by the device. In some examples, the verification request may also comprise a parameter relating to the subscription identifier. The Network node from which the verification request is received may for example be a Network Access node or a Core network node.

In step 920, the Verification node retrieves from a memory a device characteristic that has been bound to the subscription identifier presented by the device such that the subscription identifier is uniquely associated with the characteristic. The device characteristic may comprise component elements of a permanent device identity, including for example a permanent device identifier and a device specific key, where the device specific key may be a device specific public key which is associated with a corresponding device specific private key, or may be a device specific symmetric key. The permanent device identity may be bound to the subscription identifier via its permanent device identifier.

In step 930, the Verification node, may, in some examples, perform a cryptographic calculation on a parameter relating to the subscription identifier using the retrieved device characteristic. This parameter may be the parameter received with the verification request.

As discussed above, performing a cryptographic calculation on a parameter using a characteristic of the device may comprise at least one of generating a MAC for the parameter using the characteristic and/or encrypting or decrypting the parameter using the characteristic.

In step 940, the Verification node sends a response to the Network node, the response comprising at least one of the retrieved device characteristic, and/or a parameter on which a cryptographic calculation has been performed using the retrieved characteristic. The parameter on which the cryptographic calculation has been performed may be the parameter received in the verification request.

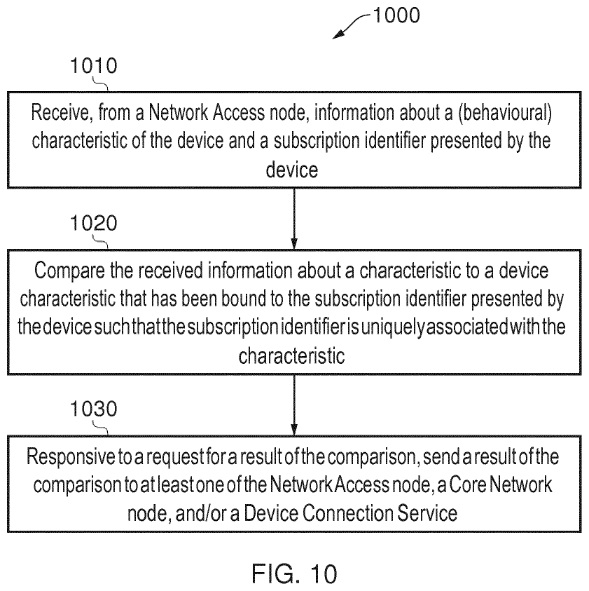

FIG. 10 is a flow chart illustrating process steps in another example of method 1000 for verifying a communication network subscription identifier associated with a device, which may be a constrained device as discussed above, the method performed by a Verification node. The method 1000 may be performed by a Verification node in examples in which the device characteristic that has been bound to a subscription identifier comprises a behavioural characteristic.

Referring to FIG. 10, the method 1000 comprises receiving in step 1010, from a Network Access node, information about a characteristic of the device and a subscription identifier presented by the device. The information about the characteristic may be received from the Network Access node via a Device Connection Service. The characteristic of the device may comprise a behavioural characteristic of the device, as discussed in greater detail above with reference to FIGS. 3 and 4.

In step 1020, the Verification node compares the received information about a characteristic to a device characteristic that has been bound to the subscription identifier presented by the device such that the subscription identifier is uniquely associated with the characteristic. In step 1030, responsive to a request for a result of the comparison, the Verification node send a result of the comparison to at least one of the Network Access node, a Core Network node and/or a Device Connection Service.

It will be appreciated that according to the method 1000, a direct comparison between a bound characteristic and a presented characteristic is performed at the Verification node. This comparison may be appropriate in examples in which a behavioural characteristic is bound to a subscription identifier. The Verification node may thus compare an expected location with an actual location (via cell identification) or any other expected with actual behaviour in accessing the network. In examples in which a permanent device identifier characteristic is bound to the subscription identifier, comparison between parameters may be carried out in the Network Access node, but this may not be a direct comparison between bound and presented characteristics, but rather a comparison of a parameter value presented by the device with an expected value for that parameter. The parameter exchange between the device, Network Access node, Core Network node and Verification node is such that the device will only have been able to obtain the correct value of the parameter sent to and compared by the Network Access node if it is in possession of the correct characteristic.

The method 1000 performed by the Verification node may be complimented by methods performed by a Core Network node and a Network Access node. For example, a Network Access node may forward connection information for a device to a DCS and the DCS may send that connection information to the Verification node. According to different examples, a Core Network node may according to different embodiments, register for monitoring of a connection by a device to the communication network. The Core Network node may request and receive a verification response from a Verification node relating to a connection by a device to the network. This may be the request that prompts the Verification node to send a result of its comparison to the Core Network node in step 1030 of the method 1000. The Core network node may alternatively send a Verification node URI to another network entity such as a Network Access node or DCS, so allowing those entities to request a verification result directly from the Verification node. In still further examples, the Core Network node may receive a report of a failed verification and suspected misuse of a subscription identifier, for example from a DCS that has contacted the Verification node, and forward the report to a Network Access node so that the Network Access node may block network access for the device.

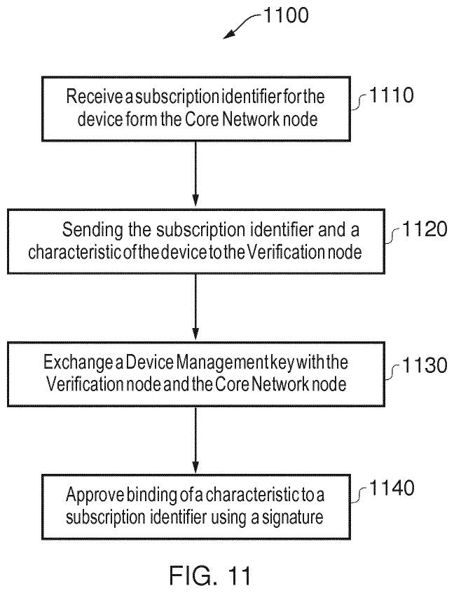

FIG. 11 is a flow chart illustrating process steps in another example of method 1100 for managing a communication network subscription identifier associated with a device, which may be a constrained device as discussed above, the method performed by a Device Management node.

Referring to FIG. 11, the method 1100 comprises receiving, in step 1110, a subscription identifier for the device from the Core Network node. The method further comprises, in step 1120, sending the subscription identifier and a characteristic of the device to the Verification node. The method may further comprise, in step 1130, exchanging a Device Management key with the Verification node and the Core Network node, and approving binding of a characteristic to a subscription identifier using a signature in step 1140.

As described above, examples of the methods 300 to 1100 cooperate to enable the efficient detection of use of cloned credentials to access a network. A device characteristic is bound to a subscription identifier assigned to the device, and the binding is verified by ensuring that a device presenting the subscription identifier is in possession of the bound characteristic. A device that is not in possession of the bound characteristic may be prevented from accessing the network, if the verification is performed during an authentication procedure, or may have network access suspended or denied, if the verification is performed after authentication. The above described methods illustrate different options for binding and verification, according to whether the device characteristic that is bound to a subscription identifier is a permanent device identity, bound via its constituent permanent device identifier, or a behavioural characteristic. Each of these options is discussed in further detail below, with reference to example implementations of the methods illustrated via the message flow diagrams shown in FIGS. 12 to 14.

The example implementations illustrated in FIGS. 12 to 14 involve a Core Network node in the form of a HSS, a Network Access node in the form of a NAAF (also known as MME in LTE, SGSN in UMTS), a device in the form of a UE, and device network services that may either be provided by the Mobile Network Operator (MNO) itself or in cooperation with the MNO. These services include the Device Connection System (DCS) and the Verification node that provides a verification service. The Verification node is represented by the Verification service (VS) that it provides in FIGS. 12 to 14. The DCS handles connectivity management and can observe and provide information about how a given device connect and uses network services. The Verification node performs binding of device characteristics to subscription identifier and assists in verification of bindings to detect fraudulent use of subscription identifiers. In cases of a roaming device, the NAAF is part of the visited network. The example implementations also involve a device management system that is responsible for management of devices. This system may be controlled by the owner of the device or licensed to a third party.

As discussed above, the two options illustrated by FIGS. 12 to 14 demonstrate two different ways in which the above entities may cooperate to check that a subscriber identity is being used by the intended device, and to detect when exfiltrated subscriber credentials are being used in a device that is different from the intended device.

### Option 1: Permanent Device Identity Characteristic

A device manufacturer of a UE registers device identities for the UE in a database (illustrated as DevDDB in FIGS. 12 to 14). Typically, each entry consists of a device identifier (e.g. product type, serial number, etc.) and the public key portion of the device key pair of the device identity. It is this information that can be bound to a subscription identifier by the Verification node, for example during registration of the device in the device management system (DevMan in FIGS. 12 to 14) when subscription is arranged for the device. In addition to the device identifier, behavioural characteristics including mobile network cell information and network functions that the device owner wishes the device to have may also be bound to the subscription identifier. The binding is handled by the Verification node (VS in FIGS. 12 to 14) based on information provided by the device management system (DevMan) and the Device Connection Service (DCS).

Specifically, the IMSI assigned to the device may be bound together with the permanent device identifier of the permanent device identity. The permanent device identifier is a piece of data that names or enumerates the identity credentials in the (name) space of all possible identifiers that are in use. As the device identity is not cloneable, and is uniquely associated with the IMSI, it is possible during, prior to, or after the authentication by the NAAF, to discover that the binding of the device identifier is not correct, or that during registration the IMSI appears again but with a different device identifier to be bound with. Such a re-binding can either be blocked or trigger a fraud alarm that temporarily blocks re-binding until proper authorisation is established and the previous registered device management owner grants permission for the re-binding to proceed. It will be appreciated that as the VS is under control of the MNO, it is always the MNO that takes the final decision to approve or disapprove the (re-binding), for example by providing a binding policy to the VS (as illustrated in step 150 of FIG. 12). The VS is registered at the MNO and a TLS certificate may be provided (as illustrated in step 110 of FIG. 12) for secure communication between the VS and the MNO.

Re-binding of a subscription identifier to a different device may be appropriate in a range of different circumstances relating to testing, handling of broken devices and repair. Legitimate rebinding use case may include:
1. Testing different devices with the same IMSI
2. Replacement of a broken device using the same IMSI
3. Subscription transfer use cases (between devices)
4. eUICC profile swapping
5. Other unknown/undefined rebinding use cases
6. Device Group to IMSI Group binding

In many circumstances, a re-binding will be authorised by a device owner and may also be authorised (double signed) by an operator. An unlock process may be used to unlock a temporarily blocked subscription in the event that a warning was triggered for a device that was not making fraudulent use of credentials.

FIG. 12 is a message flow diagram illustrating set up and registration of a device. For simplicity, the NAAF in FIG. 12 is illustrated as being located in a visited communication network.

During registration of the device in the device management system, illustrated at steps 120 to 290, the device is provided with a subscription by the MNO. This can be done in various ways, for example, using the Remote SIM Provisioning, RSP, protocol(s) as specified by the GSMA, illustrated at step 170. As illustrated in FIG. 12, the binding consists of:

Registration of the public key of the device management owner, which key can be used to check a signature accompanying a bind or re-bind instruction, step 100. Information to be passed to the VS is given to the HSS, step 110.

Registration in (remote) verification service (VS) of the pair IMSI and Permanent Device Identifier (PDI), step 240. The VS will only register a binding with this information if it is signed by the device manager, step 250. This device manager has previously registered the device in its system and organized a SIM credential for the device using existing or future procedures. Through binding of the PDI to the IMSI, the entire permanent device identity, including the PDI and the associated credential, is bound to the IMSI.

Locking of the binding against a new registration of same IMSI with another PDI, step 270.

If the binding is a rebinding, then the VS checks the incoming binding request for a confirmation of the rebinding.

The VS stores information regarding the binding (IMSI, IMEI, etc.) for later use as well as a device specific key DKey, step 290. In one example, DKey is the public key of the device identity, i.e. the public key associated with the PDI. In other examples, DKey may also be a symmetric key in order to fit with existing network authentication protocols and parameter lengths. However, DKey should be strongly linked to the PDI and may, for example, be securely derived from a device secret associated with the PDI. The derived key should then be established by an interaction between the VS and the UE or (less secure) a device database such as DevDDB where the secrets are available, and which can deliver the DKey. An example derivation of a symmetric DKey is described in detail below.

In FIG. 12, the rebinding is a consequence of registration during an attach procedure. A rebinding could also be realised as an operation that does not necessarily happen via a network attachment. There could for example be another connection, WiFi, Bluetooth, NFC, or cables, that allows IMEI and IMSI to be passed from the UE to DCS before step 210 in FIG. 12 (or alternatively passed directly from the UE to the DevMan, which may then provide this information to DCS and where step 210 of FIG. 12 is skipped). In this case the access to the DCS (or DevMan) (API) should be authenticated to prevent misuse of access to DCS (or DevMan). Rebinding will also need a confirmation from the device manager (device owner) and the MNO. MNO control is illustrated in FIG. 12 via a policy in step 150, however the MNO may wish such control to be exercised explicitly per device and per IMSI.

Binding verification can be performed in different ways, for example by the HSS, by the VS at attachment or by the VS after attachment. Binding verification by the VS may be automatically triggered when the device requests network access (for example through a DCS) or the NAAF (for example in an MME) can request binding verification by the VS. Binding verification may comprise checking that the authentication challenge response is encrypted using the DKey at the UE. The NAAF may compare the encrypted authentication challenge response to the expected (encrypted) response. In order to be able to do this, the NAAF may obtain the encrypted expected response from the HSS authentication vector or may obtain DKey (from the HSS or the VS) and encrypt the expected response. In another alternative, the UE may decrypt an encrypted rand challenge RAND during or after authentication. In this case, response verification by the NAAF against the expected response as delivered by the HSS implies that the device, in case of asymmetric keys being used, must have the correct private key associated with PDI and, in case of symmetric keys being used, must have correct DKey associated with PDI, and that the device therefore holds the correct subscribed credentials.

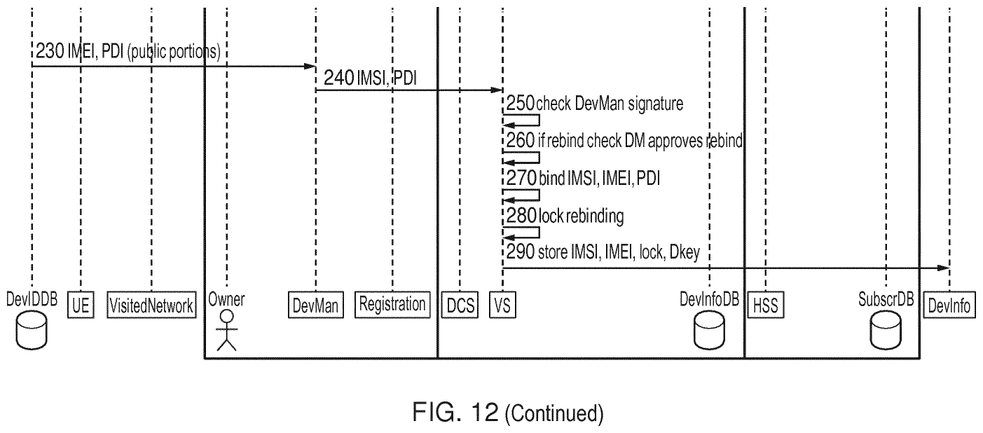

In some examples, the device and/or HSS may provide a MAC or digital signature to the NAAF, and hence to the visited network, as proof of the binding. If the NAAF is in a visited network, then only the home network knows that the subscription is associated with a device for which a VS service is available. In order to inform the NAAF of this fact, the home network (HSS) may push the URI of the VS to the NAAF together with the authentication information (AV) that the home network pushes to the visited network during an attach process. Alternatively, the home network may provide a public verification key that the visited network can use to verify the device signature. Further details of binding verification are provided below with reference to FIG. 13.

### Alternatives for IMSI and Device Identity Binding Verification

### Co-Signing at UE

Here the NAAF in the (visited) network expects the UE to deliver an extra field in a response of the AKA procedure, where this extra field is a digital signature (in the case of an asymmetric key pair associated with PDI where the private key is used to sign) or MAC (in the case a symmetric key associated with PDI where the symmetric key (DKey) is used in calculation of the MAC). The digital signature or MAC is computed on the random RAND in the AKA or the ordinary response RES. The NAAF can check this additional response field using information, from the VS or the HSS, about the correct device public key (in case of a signature) or the expected extra response field value (in case of a MAC). This option would be appropriate for situations in which the subscription credentials are traditional AKA type including EAP-AKA variants. This option may also be used in situations where network authentication is based on EAP-TLS as recently standardized for use in 5G systems. The are many possibilities of EAP-TLS exchanged data from device to network on which the signature or MAC may be computed, e.g. the resulting EMSK.

### Encryption of RAND in Authentication Vector (AV)

Another approach to verifying an explicit binding is to encrypt the random challenge value in the authentication procedure. The UE decrypts the encrypted random challenge and recovers the correct RAND to be used in the authentication procedure. The UE (or the SIM inside the UE) computes the authentication response which is sent to the NAAF.

Variant 1: In this variant, which covers two alternatives, there is no change required to an existing NAAF. In a first alternative, the HSS fetches from the VS a derived key DKey and uses this key to encrypt the RAND. The HSS provides the encrypted RAND to the NAAF in the AV and the NAAF sends this to the UE. The UE decrypts the RAND to obtain RAND such that normal AKA authentication can be performed. The NAAF may be unaware of passing on an encrypted RAND and may thus perform as specified for existing 3G, 4G and 5G networks. In a second alternative, the VS may perform the encryption of the RAND using DKey, the RAND having been provided to the VS by the HSS with a request for the VS to perform the encryption. The encrypted RAND may then be passed via the NAAF to the UE as in the first alternative. In both the above discussed alternatives, a device that uses a cloned subscription credential will not be in possession of or able to generate the same DKey as is used to encrypt the RAND (as it will not have the correct permanent device identity) and so will be unable to decrypt the RAND properly before passing it to the authentication procedures.

Variant 2: In this variant, which also covers two alternatives, changes to existing NAAFs are required. In a first alternative, RAND is encrypted using DKey by the NAAF, where DKey is obtained from VS. The UE decrypts the RAND to obtain RAND so that normal AKA authentication can be performed. In a second alternative, the VS performs encryption of RAND using DKey upon request from NAAF. This second alternative is illustrated in FIG. 13a “Verification via VS” where VS performs encryption of RAND. Referring to FIG. 13a, the HSS, on receiving an authentication request from the NAAF in the visited network (step 550), returns an Authentication Vector (AV) including RAND to the visited network and includes the URL of the appropriate VS (step 580). The visited network sends a request to the VS to encrypt RAND, including the IMSI presented by the device (step 590). The VS encrypts RAND using the DKey bound to the IMSI (step 600) and returns the encrypted RAND to the visited network (step 610). The visited network sends an authentication challenge to the UE including the encrypted RAND from the VS (step 620). The UE derives DKey from a device secret associated with PDI (step 630), decrypts the received encrypted RAND and computes RES (step 640), and returns the RES to the visited network (step 650). The visited network compares the RES received from the UE to an XRES from the AV (step 660), and grants service (step 670) if the check is successful. As for a RAND encrypted by the HSS, a device that uses a cloned subscription credential will not properly decrypt the RAND before passing it to the ordinary authentication procedures, and so will not generate the correct RES to be granted network access.

### Encryption of XRES in Authentication Vector (AV)

Instead of encrypting the random challenge value in the authentication procedure to verify an explicit binding, it is possible to encrypt the expected result XRES. After computing the ordinary authentication response RES in the AKA procedure, the UE encrypts RES with a derived symmetric key (DKey). The NAAF has received the encrypted response as the expected response XRES (encrypted), or may encrypt a received XRES using an appropriate key. At the UE side this derived key is derived from the private key or secret key associated with PDI. For example, this derivation may include parameters about the MME the NAAF is associated with (for example string “MME-MNO-name”) and the RAND in the authentication challenge the NAAF sends to the UE. The NAAF may obtain via the MME the derived key from either the VS or the HSS. The VS may also perform encryption of XRES using DKey upon request from the NAAF where the NAAF provides the XRES (that it obtained from HSS). It will be appreciated that the VS and HSS are supposed to have authenticated the MME and know the proper MME parameters in accordance with an agreement that allows the MME to access the VS or HSS services. If the NAAF is provided with an encrypted XRES, then the verification of the binding may be transparent to the NAAF, as the NAAF performs its usual comparison of RES and XRES values without knowledge that these values are encrypted. This variant is illustrated in FIG. 13b “Verification via HSS” where HSS performs encryption of XRES. Referring to FIG. 13b, the HSS, on receiving an authentication request from the NAAF in the visited network (step 320), obtains PDI and the device specific key DKey from the VS (steps 350, 360, 370, 380). The HSS then encrypts XRES using DKey (step 390) and returns encrypted XRES to the visited network with the AV (step 400). The visited network sends an authentication challenge to the UE including the RAND from the received AV (step 410). The UE derives DKey from device secret associated with PDI (step 420), computes and encrypts RES using DKey (step 430), and returns the encrypted RES to the visited network (step 440). The visited network compares the encrypted RES from the UE to the encrypted XRES from the AV (step 450), and grants service (step 460) if the check is successful.

### Post-Verification Via VS

Another approach to verifying an explicit binding is to perform a post authentication challenge-response flow. According to this approach, the UE proves possession of PDI associated private/secret key upon request. This may typically involve the UE signing a parameter using the PDI associated key. The parameter may be a challenge (which may be the RAND used in latest authentication or a new random value sent to the UE) and may involve the IMSI value. This approach is illustrated in FIG. 13c “Post verification via VS”. Referring to FIG. 13c, normal authentication is performed at steps 700 to 770, following which, information about the connection to the device is monitored (step 780 and 790). If a potential fraud is suspected on the basis of the monitored connection, the VS sends a message to the visited network (step 800) to temporarily block access and force proof of possession of the correct identifier. The visited network sends an error message (step 820) with an implicit request to sign a parameter. The UE signs the parameter, so providing proof of possession of PDI associated key and returns the signature to the visited network (step 830). The visited network forwards the signature to the VS for checking (step 840) and, in the event of misuse (the signature does not match that which should have been produced if the correct key had been used), the VS reports the misuse via the DCS (step 860) to the HSS (step 870) and the HSS instructs the visited network to terminate service (step 880 and 890).

In some of the examples above illustrated by FIGS. 12 and 13, the DKey is a public key associated with PDI. For various reasons including performance and keeping the same lengths for the encrypted RAND and XRES, it may be preferable to have DKey as a symmetric key as illustrated above using other examples related to FIGS. 12 and 13. However, DKey should be strongly linked to the PDI. For example, it may be securely derived from a device secret associated with PDI, and for example included in the permanent device identity, or the device may have an additional (master device) secret from which the DKey is derived. The derived key should be established by an interaction between the VS and the UE or (less secure) a device database such as DevDDB where the secrets are available, and which can deliver the DKey. In the cases in which the DKey is obtained from an interaction with the UE, this interaction may for example occur between steps 280 and 290 of FIG. 12. The actual derivation may be performed as:

DKey=KDF(device secret, H=hash (‘UE RANDOM’ concatenated with ‘VS parameters’))

Where KDF and hash are a key derivation functions such as HKDF, as specified by IETF in RFC 5869, and cryptographic hash function, respectively. Examples of suitable hash functions include SHA256 or SHA3. The random value UE RANDOM and VS parameters may be used to ensure that different VSs get different DKeys and that for a new registration a new DKey will be used. It may be assumed that the UE stores the hash result H so it later can re-derive DKey. The random value UE RANDOM is generated by the UE to ensure that a dishonest VS cannot obtain a derived key that another VS has legitimately obtained. VS parameters can be for example the name of the VS or its DNS address or a date, tax/vat number, etc.

In some examples, if there are circumstances that mean using the device private key directly is less favourable, it is possible to generate a key automatically based on MNO characteristics. The same procedure as a Trusted Platform Module (TPM) can regenerate a public-private pair using an internal (secret) seed and an external random value.

### Option 2: Behavioural Characteristic

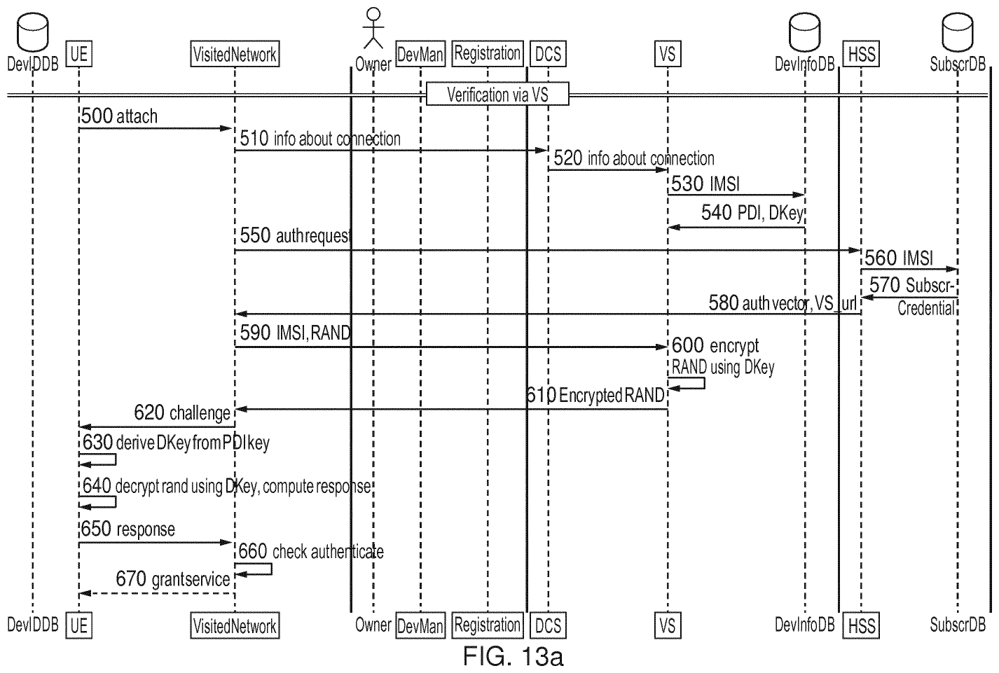

Binding and verification of binding using a behavioural characteristic are illustrated in FIGS. 14a to 14d. This option may be advantageous if a device does not have a permanent device identity but only an assigned identifier such as an International Mobile Equipment Identity (IMEI), which can be changed or cloned and so is not a basis for a secure binding between device and subscription identity. A behavioural characteristic may be provided by a Device Connection Service (DCS) when the device is registered. The behavioural characteristic may for example include information, provided by the device owner, about how the device connects to the network. This behaviour may then be observed by the DCS when the device connects to the network and/or during registration, in order to enable a comparison with the behaviour characteristic bound to the subscriber identifier presented by the device. For example, a device owner can indicate that a device is a stationary device such as a temperature sensor or a pump valve controller, in which case the DCS can record the network cell number and other network characteristics for binding to the subscriber identifier assigned to the device. In some examples a non-permanent device identifier may also be included in the binding.

Binding during device registration is illustrated in FIG. 14a. An IMEI, assigned IMSI and expected behavioural information for a device are provided to a device management system by a device owner (step 170). This information is forwarded to the VS (step 210) and the VS performs appropriate checks of accompanying signatures and approvals as discussed above before binding the behavioural characteristic, in the form of expected behavioural information, to the assigned IMSI (steps 220 to 260). The DCS can observe the behaviour of the device when it seeks to connect (steps 310 and 510), or the gathered DCS information of the device at the time of registration can be used, or both, for the purposes of assembling behavioural information. For example, the device owner can indicate that the device is a stationary device, for example a temperature sensor or a pump valve controller. The DCS may then record the network cell number and other network characteristics at step 190 and locks them against re-registration. The DCS and VS thus work together; the DCS provides behavioural information/status of the UE and the VS performs binding and verification of observed behaviour.

As discussed above with reference to FIG. 12, the binding illustrated in FIG. 14a is triggered by an attach procedure, but explicit rebinding may also be envisaged.

Binding verification in the case of a behavioural characteristic may also be achieved in arrange of different ways, and three alternatives are illustrated in FIGS. 14 b, 14c and 14d. In a first alternative, illustrated in FIG. 14b “Verification via HSS”, the DCS observes the network characteristics (step 310) of a device connecting to the network (step 300). The observed behavioural characteristics are passed to the VS (step 320), which compares the observations with the registered information (steps 330 and 340). The VS performs an analysis based on the registered information and potentially logged information about the device network history and declares that connectivity is normal or is potentially fraudulent on request from the HSS (steps 380 and 390). The HSS then either proceeds to generate and send an Authentication Vector or signal misuse accordingly.

In another alternative, illustrated in FIG. 14c “Verification via Visited Network”, the NAAF requests a verification check from the VS (step 580) after receiving the AV and a VS URI from the HSS (step 570) but before sending the authentication challenge to the UE (step 620). As in the illustrated example, the NAAF is in a visiting network (MME), only the HSS in the home network knows that a presented subscription identifier is associated with a device for which a VS service is available. To inform the NAAF, the home network therefore pushes the URI of the VS to the visited network together with the authentication information that the home network pushes to the visiting network under the authentication procedure when the device wants to attach. On receipt of the verification check request from the visited network, the VS again performs an analysis based on the registered information and potentially logged information about the device network history from the DCS (step 520) and declares that connectivity is normal or is potentially fraudulent (step 610). The visited network then either proceeds with authentication or denies network access.

In another alternative, illustrated in FIG. 14d “Post verification via DCS/VS”, the DCS monitors network connection behaviour of an authenticated device (step 680), and whenever a significant change occurs in the DCS observed network/device information, the DCS may request a verification check from the VS (step 690). The VS performs a binding check (steps 700, 710) and reports the result to the DCS (step 720). In the case of misuse, the DCS send a report to the HSS (step 730), which then reports subscription misuse to the visited network (step 740), allowing the visited network to terminate service to the device (step 750). The visited network may be informed using standard network procedures that access should not be granted or should be terminated. If the change in network behaviour has a legitimate cause, then network access may be suspended until the new network behaviour characteristic is bound to the subscription identifier used by the device in a rebinding procedure approved by the device management system (representing the owner or user of the device).

FIGS. 12 to 14 thus illustrate different ways in which the methods 300 to 1100 may be implemented. As discussed above, the methods 300 to 1100 are performed by a Verification node, Device, Network Access node, Core Network Node and Device Management node respectively. The present disclosure provides a Verification node, Device, Network Access node, Core Network Node and Device Management node which are adapted to perform any or all of the steps of the above discussed methods.

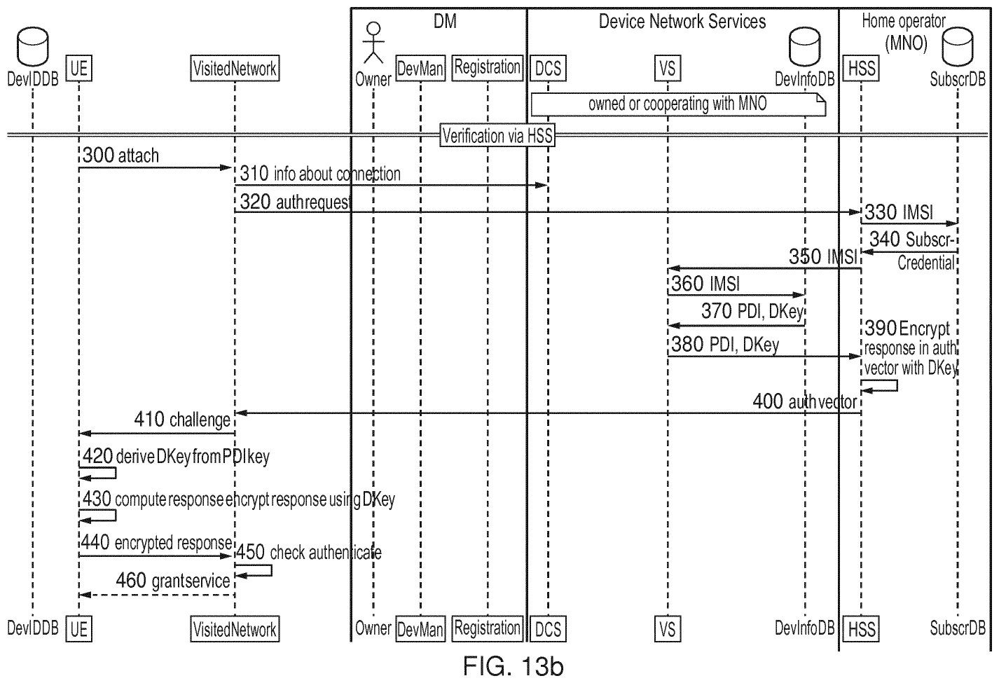

FIG. 15 is a block diagram illustrating a Verification node 1500 which may implement the method 300, 400, 900 and/or 1000 according to examples of the present disclosure, for example on receipt of suitable instructions from a computer program 1550. Referring to FIG. 15, the Verification node 1500 comprises a processor or processing circuitry 1502, and may comprise a memory 1504 and interfaces 1506. The processing circuitry 1502 is operable to perform some or all of the steps of the method 300, 400, 900 and/or 1000 as discussed above with reference to FIGS. 3 and 4. The memory 1504 may contain instructions executable by the processing circuitry 1502 such that the Verification node 1500 is operable to perform some or all of the steps of the method 300, 400, 900 and/or 1000. The instructions may also include instructions for executing one or more telecommunications and/or data communications protocols. The instructions may be stored in the form of the computer program 1550.

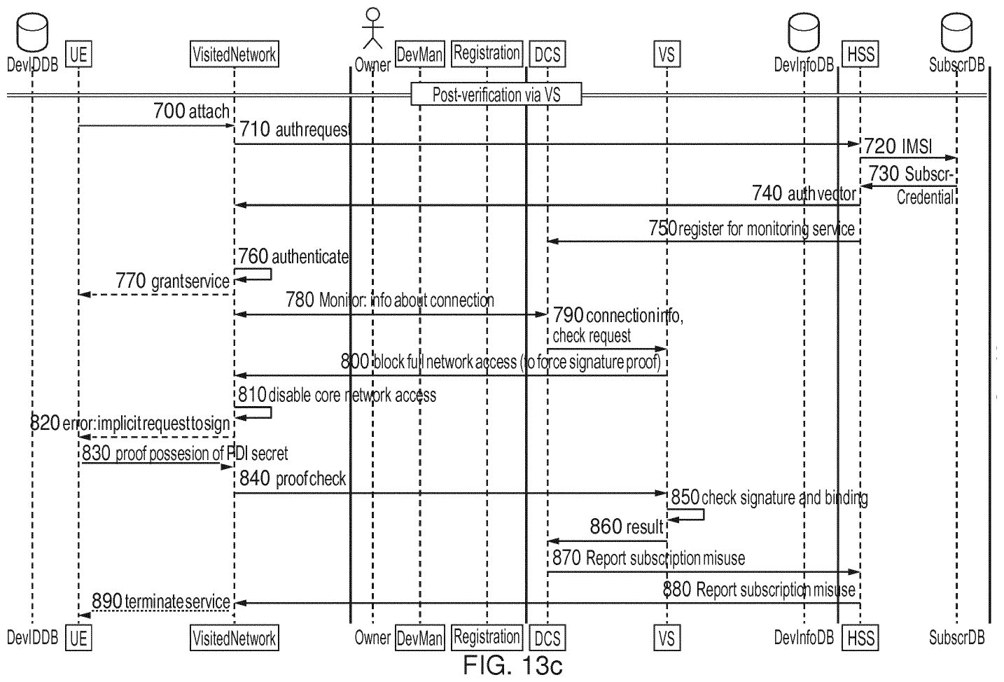

FIG. 16 is a block diagram illustrating a device 1600 which may implement the method 500 according to examples of the present disclosure, for example on receipt of suitable instructions from a computer program 1650. Referring to FIG. 16, the device 1600 comprises a processor or processing circuitry 1602, and may comprise a memory 1604 and interfaces 1606. The processing circuitry 1602 is operable to perform some or all of the steps of the method 500 as discussed above with reference to FIG. 5. The memory 1604 may contain instructions executable by the processing circuitry 1602 such that the device 1600 is operable to perform some or all of the steps of the method 500. The instructions may also include instructions for executing one or more telecommunications and/or data communications protocols. The instructions may be stored in the form of the computer program 1650.

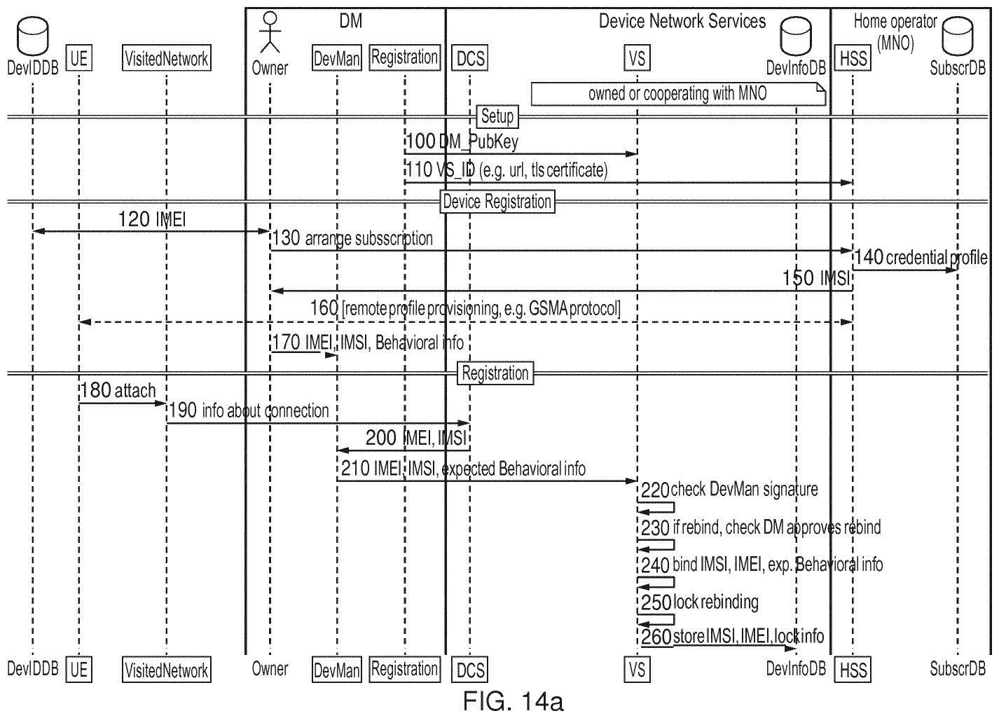

FIG. 17 is a block diagram illustrating a Network Access node 1700 which may implement the method 600 according to examples of the present disclosure, for example on receipt of suitable instructions from a computer program 1750. Referring to FIG. 17, the Network Access node 1700 comprises a processor or processing circuitry 1702, and may comprise a memory 1704 and interfaces 1706. The processing circuitry 1702 is operable to perform some or all of the steps of the method 600 as discussed above with reference to FIG. 6. The memory 1704 may contain instructions executable by the processing circuitry 1702 such that the Network Access 1700 is operable to perform some or all of the steps of the method 600. The instructions may also include instructions for executing one or more telecommunications and/or data communications protocols. The instructions may be stored in the form of the computer program 1750.

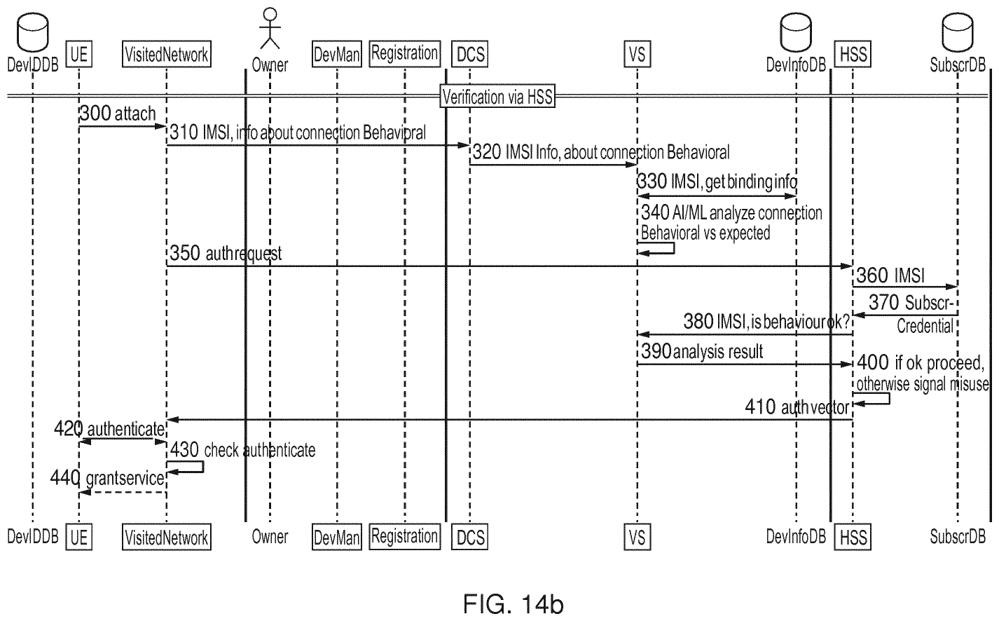

FIG. 18 is a block diagram illustrating a Core Network node 1800 which may implement the method 700 and/or 800 according to examples of the present disclosure, for example on receipt of suitable instructions from a computer program 1850. Referring to FIG. 18, the Core Network node 1800 comprises a processor or processing circuitry 1802, and may comprise a memory 1804 and interfaces 1806. The processing circuitry 1802 is operable to perform some or all of the steps of the method 700 and/or 800 as discussed above with reference to FIGS. 7 and 8. The memory 1804 may contain instructions executable by the processing circuitry 1802 such that the Core Network node 1800 is operable to perform some or all of the steps of the method 700 and/or 800. The instructions may also include instructions for executing one or more telecommunications and/or data communications protocols. The instructions may be stored in the form of the computer program 1850.

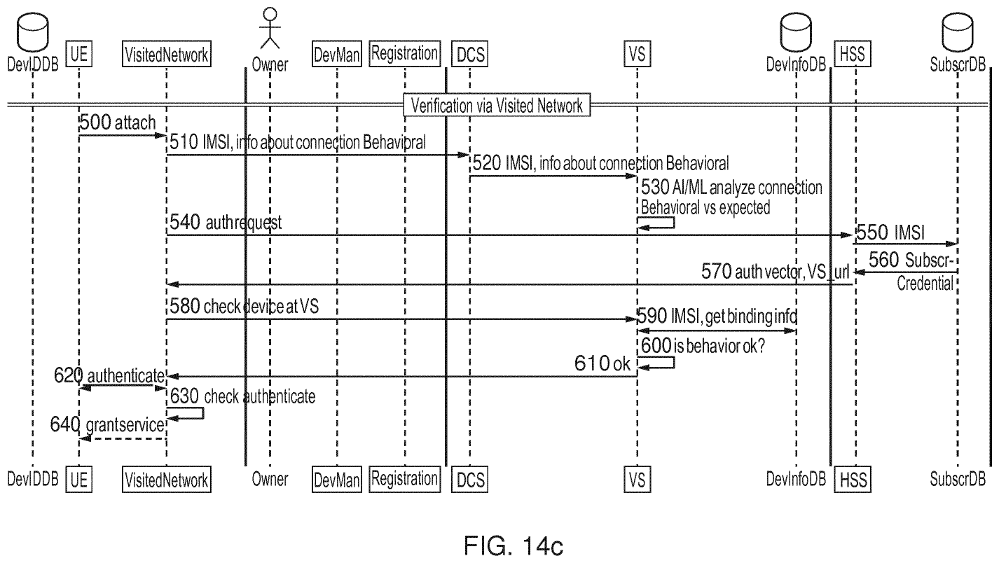

FIG. 19 is a block diagram illustrating a Device Management node 1900 which may implement the method 1100 according to examples of the present disclosure, for example on receipt of suitable instructions from a computer program 1950. Referring to FIG. 19, the Device Management node 1900 comprises a processor or processing circuitry 1902, and may comprise a memory 1904 and interfaces 1906. The processing circuitry 1902 is operable to perform some or all of the steps of the method 1100 as discussed above with reference to FIG. 11. The memory 1904 may contain instructions executable by the processing circuitry 1902 such that the Device Management node 1900 is operable to perform some or all of the steps of the method 1100. The instructions may also include instructions for executing one or more telecommunications and/or data communications protocols. The instructions may be stored in the form of the computer program 1950.

In some examples, the processor or processing circuitry 1502, 1602, 1702, 1802, 1902 described above may include one or more microprocessors or microcontrollers, as well as other digital hardware, which may include digital signal processors (DSPs), special-purpose digital logic, etc. The processor or processing circuitry 1502, 1602, 1702, 1802, 1902 may be implemented by any type of integrated circuit, such as an Application Specific Integrated Circuit (ASIC), Field Programmable Gate Array (FPGA) etc. The memory 1504, 1604, 1704, 1804, 1904 may include one or several types of memory suitable for the processor, such as read-only memory (ROM), random-access memory, cache memory, flash memory devices, optical storage devices, solid state disk, hard disk drive etc.

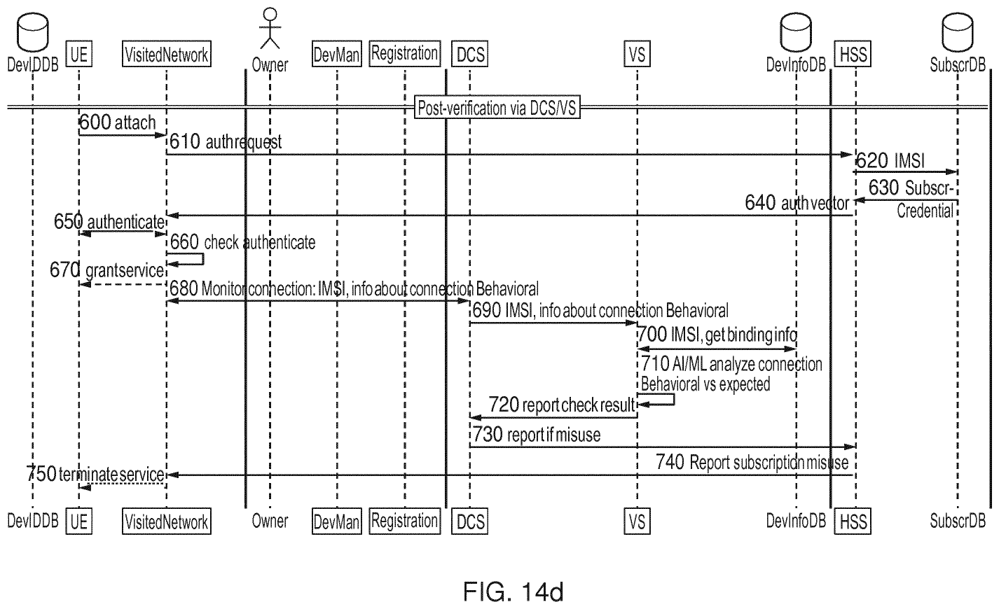

FIG. 20 illustrates functional units in another example of Verification node 2000 which may execute examples of the methods 300 and/or 400 of the present disclosure, for example according to computer readable instructions received from a computer program. It will be understood that the units illustrated in FIG. 20 are functional units, and may be realised in any appropriate combination of hardware and/or software. The units may comprise one or more processors and may be integrated to any degree.

Referring to FIG. 20, the Verification node 2000 comprises a receiving module 2002 for receiving, from a Device Management node with management responsibility for the device, a subscription identifier for the device and a characteristic of the device, and a binding module 2004 for binding the subscription identifier to the characteristic such that the subscription identifier is uniquely associated with the characteristic. The Verification node further comprises a storage module 2006 for storing the bound subscription identifier and characteristic in a memory. The Verification node may further comprise interfaces 2008.

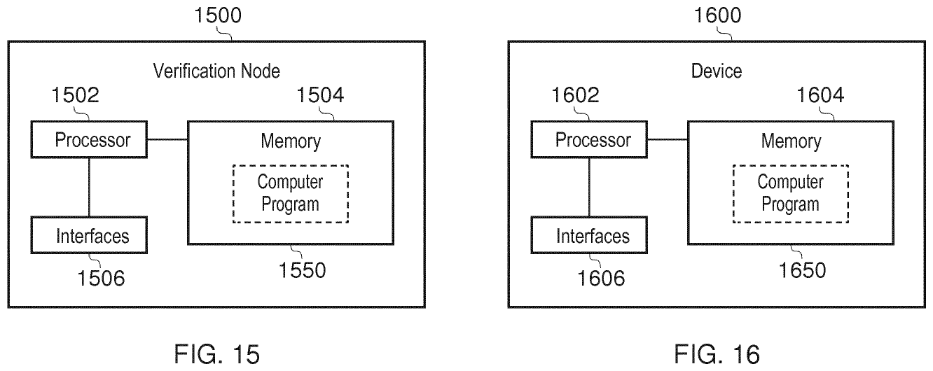

FIG. 21 illustrates functional units in another example of Device 2100 which may execute examples of the method 500 of the present disclosure, for example according to computer readable instructions received from a computer program. It will be understood that the units illustrated in FIG. 21 are functional units, and may be realised in any appropriate combination of hardware and/or software. The units may comprise one or more processors and may be integrated to any degree.

Referring to FIG. 21, the device 2100 comprises a receiving module 2102 for receiving a parameter from a Network Access node, and a generating module 2104 for generating, on the basis of the received parameter, a parameter for sending to the Network Access node. The device 2100 further comprises a transmission module 2106 for sending the generated parameter to the Network Access node, and a calculation module 2108 for performing a cryptographic calculation on at least one of the received parameter or the generated parameter using a characteristic of the device, wherein the characteristic of the device has been bound to a subscription identity associated with the device such that the subscription identifier is uniquely associated with the characteristic. The device may further comprise interfaces 2110.

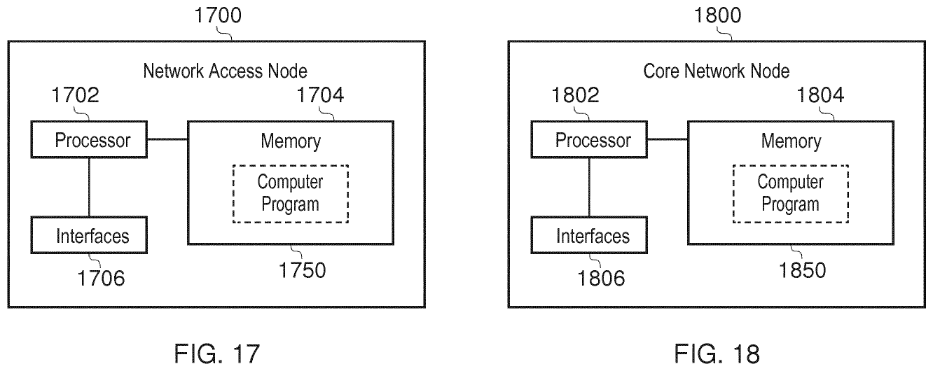

FIG. 22 illustrates functional units in another example of Network Access node 2200 which may execute examples of the method 600 of the present disclosure, for example according to computer readable instructions received from a computer program. It will be understood that the units illustrated in FIG. 22 are functional units, and may be realised in any appropriate combination of hardware and/or software. The units may comprise one or more processors and may be integrated to any degree.

Referring to FIG. 22, the Network Access node comprises a transmission module 2202 for sending a verification request to a Network node, the verification request comprising a subscription identifier presented by the device, and a receiving module 2204 for receiving a response from the Network node, the response comprising at least one of: a device characteristic that has been bound to the subscription identifier presented by the device such that the subscription identifier is uniquely associated with the characteristic, a parameter on which a cryptographic calculation has been performed using such a characteristic, or an identification of a Verification node from which either the device characteristic or parameter may be obtained. The transmission node 2202 is additionally for sending a parameter to the device. The receiving module 2204 is additionally for receiving a parameter from the device. The Network Access node 2200 further comprises a checking module 2206 for checking that the received parameter matches an expected received parameter for the device. At least one of the parameter sent to the device or the parameter received from the device comprises a parameter on which a cryptographic calculation has been performed using a device characteristic that has been bound to the subscription identifier presented by the device such that the subscription identifier is uniquely associated with the characteristic. The Network Access module 2200 may further comprise interfaces 2208.

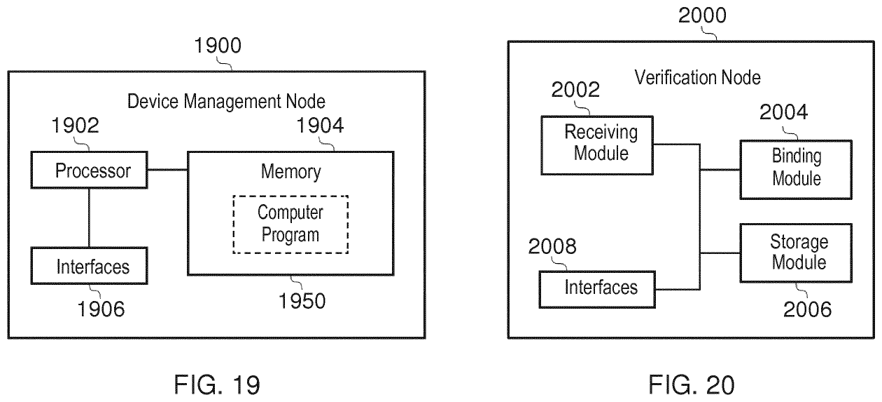

FIG. 23 illustrates functional units in another example of Core Network node 2300 which may execute examples of the methods 700 and/or 800 of the present disclosure, for example according to computer readable instructions received from a computer program. It will be understood that the units illustrated in FIG. 23 are functional units, and may be realised in any appropriate combination of hardware and/or software. The units may comprise one or more processors and may be integrated to any degree.

Referring to FIG. 32, the Core Network node 2300 comprises a receiving module 2302 for receiving a verification request from a Network Access node, the verification request comprising a subscription identifier presented by the device, and a transmission module 2304 for sending a response to the Network Access node, the response comprising at least one of: a device characteristic that has been bound to the subscription identifier presented by the device such that the subscription identifier is uniquely associated with the characteristic, a parameter on which a cryptographic calculation has been performed using such a characteristic, or an identification of a Verification node from which either the device characteristic or parameter may be obtained. The Core Network node may further comprise interfaces 2306.

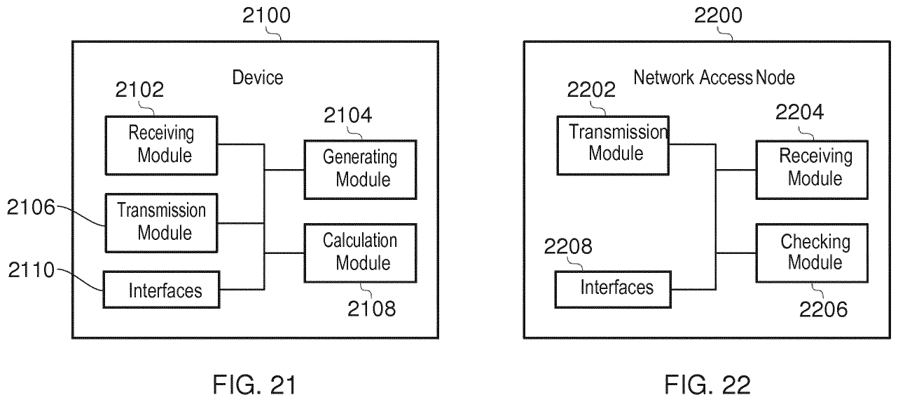

FIG. 24 illustrates functional units in another example of Verification node 2400 which may execute examples of the method 900 of the present disclosure, for example according to computer readable instructions received from a computer program. It will be understood that the units illustrated in FIG. 24 are functional units, and may be realised in any appropriate combination of hardware and/or software. The units may comprise one or more processors and may be integrated to any degree.

Referring to FIG. 24, the Verification node 2400 comprises a receiving module 2402 for receiving a verification request from a Network node, the verification request comprising a subscription identifier presented by the device, and a memory module 2404 for retrieving from a memory a device characteristic that has been bound to the subscription identifier presented by the device such that the subscription identifier is uniquely associated with the characteristic. The Verification node 2400 further comprises a transmission module 2406 for sending a response to the Network node, the response comprising at least one of: the retrieved device characteristic or a parameter on which a cryptographic calculation has been performed using the retrieved characteristic. The Verification node 2400 may further comprise interfaces 2408.

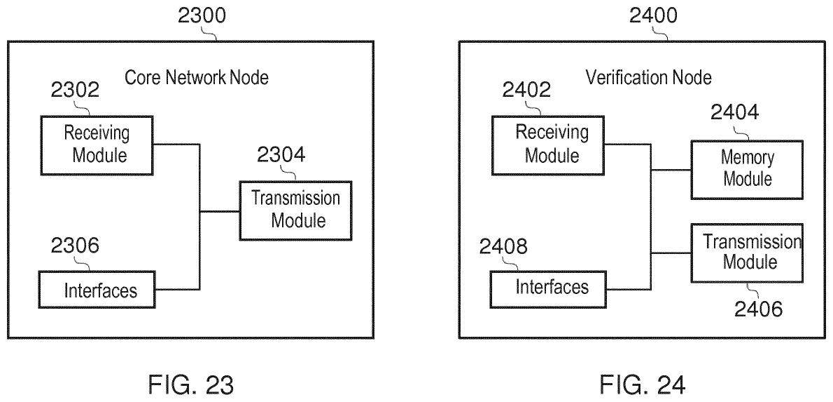

FIG. 25 illustrates functional units in another example of Verification node 2500 which may execute examples of the method 1000 of the present disclosure, for example according to computer readable instructions received from a computer program. It will be understood that the units illustrated in FIG. 25 are functional units, and may be realised in any appropriate combination of hardware and/or software. The units may comprise one or more processors and may be integrated to any degree.

Referring to FIG. 25, the Verification Node 2500 comprises a receiving module 2502 for receiving, from a Network Access node, information about a characteristic of the device and a subscription identifier presented by the device. The Verification node 2500 further comprises a comparison module for comparing the received information about a characteristic to a device characteristic that has been bound to the subscription identifier presented by the device such that the subscription identifier is uniquely associated with the characteristic. The Verification node 2500 further comprises a transmission module 2506 for, responsive to a request for a result of the comparison, sending a result of the comparison to at least one of: the Network Access node, a Core Network node, or a Device Connection Service. The Verification node may further comprise interfaces 2508.

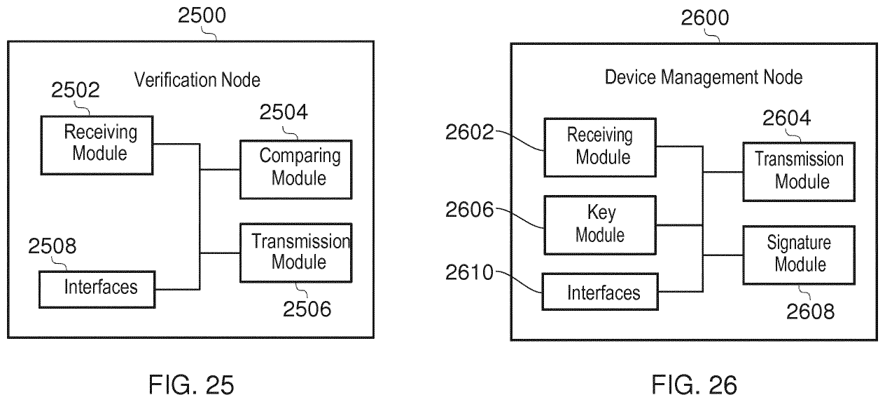

FIG. 26 illustrates functional units in another example of Device Management node 2600 which may execute examples of the method 1100 of the present disclosure, for example according to computer readable instructions received from a computer program. It will be understood that the units illustrated in FIG. 26 are functional units, and may be realised in any appropriate combination of hardware and/or software. The units may comprise one or more processors and may be integrated to any degree.

Referring to FIG. 26, the Device Management node comprises a receiving module for receiving a subscription identifier for the device from the Core Network node, and a transmission module 2604 for sending the subscription identifier and a characteristic of the device to the Verification node. The Device Management node may further comprise a key module 2606 for exchanging a Device Management key with the Verification node and the Core Network node, and a signature module for approving binding of a characteristic to a subscription identifier using a signature. The Device Management node 2600 may further comprise interfaces 2610.

It will be appreciated that examples of the present disclosure may be virtualised, such that the nodes described herein may be instantiated across one or more virtual nodes in a cloud environment, and the methods and processes described herein may be run in a cloud environment.

Aspects of the present disclosure thus provide methods and nodes performing such methods that enable the binding of one or more characteristics associated with a device to a subscription identifier assigned to the device. The one or more characteristics may include a permanent device identifier and/or device behavior in the network. Examples of the methods and nodes herein also enable efficient verification that a device seeking to connect or connected to the network is in possession of the device characteristic that is bound to the subscription identifier presented by the device. A device failing to demonstrate possession of a bound characteristic may be refused access to the network. Control over network access is no longer entirely coupled to the hardware and procedural security of the (e)UICC. Aspects of the present disclosure thus offer more cost effective iUICC solutions, mitigating the risk associated with introducing subscription credential storage solutions in devices that have higher risk of compromise that could lead to subscription fraud. In addition, examples of the present disclosure support effective binding and rebinding procedures for device and subscription credentials, giving device owners better assurance that acquired subscription credentials only can be used for their devices, and supporting a range of use cases including testing and replacement of devices.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality and a single processor or other unit may fulfil the functions of several units recited in the claims. Any reference signs in the claims shall not be construed so as to limit their scope.

1. A system for managing a communication network subscription identifier associated with a device, the system comprising:
a Core Network node configured to provide a subscription identifier for the device to a Device Management node with management responsibility for the device;
a Verification node configured to receive from the Device Management node the subscription identifier and a characteristic of the device, and to bind the subscription identifier to the characteristic such that the subscription identifier is uniquely associated with the characteristic; and
a Network Access node configured to obtain the subscription identifier from the device;
wherein the Verification node, Network Access node and Core Network node are configured to cooperate to verify that the device from which the Network Access node obtained the subscription identifier is in possession of the characteristic that is bound to the subscription identifier.

2. The system as claimed in claim 1, wherein the Verification node, Network Access node and Core Network node are configured to cooperate to verify that the device from which the Network Access node obtained the subscription identifier is in possession of the characteristic that is bound to the subscription identifier by performing at least one of:
obtaining an observed characteristic of the device and comparing the observed characteristic to the characteristic that is bound to the subscription identifier; or
performing a cryptographic calculation using the characteristic that is bound to the subscription identifier, causing the device to perform a corresponding cryptographic calculation using a characteristic in its possession, and using the results of the cryptographic calculations to verify that the characteristic that is bound to the subscription identifier is the same as the characteristic that is in the possession of the device.

3. The system as claimed in claim 2, wherein the Verification node, Network Access node and Core Network node are configured to perform a cryptographic calculation using the characteristic that is bound to the subscription identifier, cause the device to perform a corresponding cryptographic calculation using a characteristic in its possession, and use the results of the cryptographic calculations to verify that the characteristic that is bound to the subscription identifier is the same as the characteristic that is in the possession of the device during a network authentication procedure for the device.

4. A method for managing a communication network subscription identifier associated with a device, the method, performed by a Verification node, comprising:
receiving, from a Device Management node with management responsibility for the device, a subscription identifier for the device and a characteristic of the device;
binding the subscription identifier to the characteristic such that the subscription identifier is uniquely associated with the characteristic; and
storing the bound subscription identifier and characteristic in a memory.

5. The method as claimed in claim 4, further comprising:
receiving a Device Management key associated with a Manager of the device; and
checking a signature included with the received subscription identifier and characteristic of the device using the Device Management key.

6. The method as claimed in claim 4, further comprising:
sending, to a Core Network node, an identification of the Verification node, wherein the identification comprises a Uniform Resource Identifier(URI) of the Verification node.

7. The method as claimed in claim 4, further comprising:
receiving, from a Core Network node, a subscription identifier binding policy and a subscription identifier to which the policy applies; and
on receipt from the Device Management node of the subscription identifier and device characteristic:
checking whether a subscription identifier binding policy that applies to the subscription identifier received from the Device Management node has been received; and
if such a subscription identifier binding policy has been received, checking whether binding of the subscription identifier received from the Device Management node to the characteristic received from the Device Management node is consistent with the subscription identifier binding policy.

8. The method as claimed in claim 4, wherein the characteristic of the device received from the Device Management node comprises at least one of:
a behavioural characteristic; or
component elements of a permanent device identity.

9. A method for verifying a communication network subscription identifier associated with a device, the method, performed by the device, comprising:
receiving a parameter from a Network Access node;
generating, on the basis of the received parameter, a parameter for sending to the Network Access node; and
sending the generated parameter to the Network Access node, the method further comprising:
performing a cryptographic calculation on at least one of the received parameter or the generated parameter using a characteristic of the device, wherein the characteristic of the device has been bound to a subscription identity associated with the device such that the subscription identifier is uniquely associated with the characteristic.

10. The method as claimed in claim 9, wherein performing a cryptographic calculation on at least one of the received parameter or the generated parameter using a characteristic of the device comprises at least one of:
signing at least one of the received parameter or the generated parameter using the characteristic;
generating a Message Authentication Code(MAC) for at least one of the received parameter or the generated parameter using the characteristic;
encrypting or decrypting at least one of the received parameter or the generated parameter using the characteristic.

11. A method for verifying a communication network subscription identifier associated with a device, the method, performed by a Network Access node, comprising:
sending a verification request to a Network node, the verification request comprising a subscription identifier presented by the device;
receiving a response from the Network node, the response comprising at least one of:
a device characteristic that has been bound to the subscription identifier presented by the device such that the subscription identifier is uniquely associated with the characteristic;
a parameter on which a cryptographic calculation has been performed using such a characteristic; or
an identification of a Verification node from which either the device characteristic or parameter may be obtained; the method further comprising:
sending a parameter to the device;
receiving a parameter from the device; and
checking that the received parameter matches an expected received parameter for the device;
wherein at least one of the parameter sent to the device or the parameter received from the device comprises a parameter on which a cryptographic calculation has been performed using a device characteristic that has been bound to the subscription identifier presented by the device such that the subscription identifier is uniquely associated with the characteristic.

12. The method as claimed in claim 11, further comprising:
performing a cryptographic calculation on at least one of:
the expected received parameter for the device; or
the parameter sent to the device;
using the device characteristic that has been bound to the subscription identifier presented by the device such that the subscription identifier is uniquely associated with the characteristic.

13-36. (canceled)
